(19) United States
(12) Patent Application Publication
(10) Pub. No.: US 2025/0314264 A1
(43) Pub. Date: Oct. 9, 2025

(54) CONNECTOR FOR MECHANICALLY FASTENING A FIRST COMPONENT TO A SECOND COMPONENT, AND COMPONENT CONNECTION

(71) Applicant: Festool GmbH, Wendlingen (DE)

(72) Inventors: Matthias Tenter, Esslingen a.N. (DE); Marco Haible, Wernau (DE); Johannes Rau, Plochingen (DE); David Grimm, Filderstadt (DE); Vitus Rommel, Lenningen (DE); Steffen König, Schwaebisch Gmuend (DE)

(73) Assignee: Festool GmbH, Wendlingen (DE)

(21) Appl. No.: 18/873,130

(22) PCT Filed: Jun. 5, 2023
(86) PCT No.: PCT/EP2023/064964

§ 371 Date: Dec. 9, 2024

(30) Foreign Application Priority Data
Jun. 10, 2022 (DE) 10 2022 005 031.5

(51) Int. Cl. F16B 12/20

(52) U.S. Cl. CPC F16B 12/2027

(57) ABSTRACT

A connector mechanically fastens a first component to a second component. The first component has at least a first coupling groove which has a first undercut, effective along a groove depth direction. The second component has at least a second coupling groove which has a second undercut, effective along a groove depth direction. The connector is plate-like or flat-bar-like. The connector has a first engagement element for anchoring in the first undercut and a second engagement element for anchoring in the second undercut. The connector has an urging member for positioning at least part of the first engagement element in the first undercut and at least part of the second engagement element in the second undercut. The urging member is kinematically coupled to the first engagement element and the second engagement element. A component connection also includes the first component, the second component, and a connector of this type.

The invention relates to a connector for mechanically fastening a first component to a second component. The first component has at least a first coupling groove which has a first undercut which is effective along a groove depth direction. The second component has at least a second coupling groove which has a second undercut which is effective along a groove depth direction.

The invention is also directed to a component connection which comprises a first component having at least a first coupling groove. A groove opening of the first coupling groove lies in a contact surface of the first component. Furthermore, the first coupling groove has a first undercut which is effective along a groove depth direction. The component connection also comprises a second component having at least a second coupling groove. A groove opening of the second coupling groove lies in a contact surface of the second component. Moreover, the second coupling groove has a second undercut which is effective along a groove depth direction. The component connection additionally comprises a connector of the type stated in the introduction.

In this regard, a groove depth direction is understood to be a direction which extends between a groove opening and a groove base. A groove opening is typically elongate. Otherwise, this is referred to as a hole or a bore. In general, the groove opening is opposite the groove base. In the case of a groove which is defined on both sides along its direction of progression, the groove opening is the only opening of the groove. In the case of a groove which has an open end and two open ends along its direction of progression, only the opening extending along the direction of progression is considered to be a groove opening.

The one open end or the two open ends thus do not form a groove opening. The same applies to openings which are produced from other design elements, e.g. transverse grooves or transverse bores. In this regard, a direction in parallel with the longer side of the elongate groove opening is to be considered to be the direction of progression or the extension direction. Grooves which have a groove depth which changes along the direction of progression such that the groove depth at one or at both ends of the groove decreases to zero are considered to be grooves which are defined on one side or both sides.

Accordingly, an undercut which is effective along a groove depth direction has an undercutting in relation to a direction from the groove base to the groove opening. Therefore, an element which engages into the undercut cannot be drawn out of the groove along the groove depth direction because it forms a form-fitting connection with the undercut.

Such undercuts and the associated coupling grooves can be produced with known tools using known methods. The tools can be stationary or hand-guided.

Connector and component connections of the type stated in the introduction are fundamentally known. They are used e.g. in order to mechanically fasten components consisting of wood to one another, i.e. to connect them. Such components can be furniture parts. Alternatively, the components can be structural elements of a wood construction, e.g. from the construction industry. However, it is understood that the connectors and component connections stated in the introduction are not restricted to a specific material class or a specific field of application. They can also be readily used for components consisting of synthetic material, metal, ceramic, stone etc.

In all feasible applications, the undercuts which are effective along an associated groove depth direction have the advantage that the components can be fastened to one another in a very reliable manner. In this case, a form-fitting connection can be established by means of the undercuts. This applies in particular in comparison with coupling grooves which do not have any such undercut.

The object of the present invention is to provide a connector and an allocated component connection which are simple and cost effective and in which the connection is known to be very reliable.

The object is achieved by a connector for mechanically fastening a first component to a second component. The first component has at least a first coupling groove which has a first undercut which is effective along a groove depth direction. The second component has at least a second coupling groove which has a second undercut which is effective along a groove depth direction. The connector is two-dimensional or flat bar-shaped. In addition, the connector has a first engagement element for anchoring in the first undercut and a second engagement element for anchoring in the second undercut. Additionally, the connector comprises an urging body for positioning at least a portion of the first engagement element in the first undercut and at least a portion of the second engagement element in the second undercut. The urging body is kinematically coupled to the first engagement element and the second engagement element. In this regard, the first undercut can be arranged in the region of the groove base of the first coupling groove. Alternatively or in addition, the second undercut can be arranged in the region of the groove base of the second coupling groove. By means of its two-dimensional shape or flat bar shape, the connector is particularly well suited for connecting components via coupling grooves. In the mounted state of the connector, a thickness direction of the connector which corresponds to the smallest spatial dimension of the connector extends along a groove width direction, i.e. perpendicularly to a direction of progression of the groove and perpendicularly to the groove depth direction. As a result, the connector can be used effectively in component connections which can fill only a comparatively small installation space. This applies in particular to the use of the connector for connecting two-dimensional components. In such an application, in the mounted state the thickness direction of the connector extends in parallel with a thickness direction of the two-dimensional component. Furthermore, the two-dimensional shape or flat bar shape has the advantage that a holding force which is effective between the connector and each of the first and second component is effective in a manner distributed over a comparatively large portion of the first component and of the second component. The holding force is introduced into the respective component via a line contact between the connector and the first and/or second component or via a surface contact between the connector and the first and/or second component. Therefore, comparatively small mechanical stresses are produced within the first component and the second component. In addition, a linear or surface-to-surface engagement can be established between the connector and the first undercut and/or the second undercut. This results in particularly secure and reliable fastening of the first component and the second component to one another. This is aided by the fact that the connector has both a first engagement element and a second engagement element and that a single urging body is provided for both engagement elements. In this regard, the urging body can both position the engagement elements into the respectively allocated undercut and also position the engagement elements within the respectively allocated undercut. In the mounted state, the connector is thus anchored in the first component and in the second component at the same time. Therefore, the engagement elements can also be referred to as anchoring elements or as jaws. On the one hand, such a connector is constructed in a structurally simple manner, which favours cost-effective production. On the other hand, it is simple to use because components can be fastened to one another quickly and easily by means of such a connector.

In the present case, a kinematic coupling of two elements is to be understood to mean that these two elements can be moved only in dependence upon one another. This means that in a case in which a first one of the two elements is moved, the second one of the two elements is also moved. The movement of the second element can be subjected to restrictions which result from the movement of first element. The movement of the two elements can be the same or different.

In a first example of a kinematic coupling, the first element and the second element are fixedly connected. Therefore, they always move together. In a second example of a kinematic coupling, the first element and the second element are movably coupled. This means that the first element and the second element can moved relative to one another, but these movements are dependent upon one another. Specifically for the urging body, the first engagement element and the second engagement element which are kinematically coupled, this means that the urging body can be fixedly connected to the first engagement element and/or the second engagement element. Alternatively, the first engagement element and/or the second engagement element can be movably coupled to the urging body. In this alternative, the first engagement element and/or the second engagement element can thus be moved relative to the urging body, wherein the movement of the first engagement element and/or of the second engagement element is preferably dependent upon a movement of the urging body.

It is noted that the effects and advantages explained with reference to the two-dimensional shape or flat bar shape are evident in particular with respect to circular-cylindrical or round bar-shaped connectors because, in comparison therewith, two-dimensional or flat bar-shaped connectors can be coupled to the components, which are to be connected, over comparatively large portions thereof. In this regard, a specified component thickness frequently means that at least one dimension of the connector cannot be increased arbitrarily. In the case of a circular-cylindrical or round bar-shaped connector, this is typically the diameter. In the case of two-dimensional or flat bar-shaped connectors, merely the associated thickness is restricted by the component thickness. The remaining dimensions can be adapted substantially freely.

Furthermore, it is understood that the first engagement element and the second engagement element must protrude at least in the mounted state and at least locally with respect to the remaining components of the two-dimensional or flat bar-shaped connector in order to be able to engage into the allocated undercut. Preferably, the first engagement element and the second engagement element protrude from the connector in parallel with the thickness direction thereof.

Furthermore, by reason of the kinematic coupling a connector in accordance with the present invention is always designed as a cohesive unit. This applies to the entire usage phase of the connector. This means that, as soon as the connector is produced, it forms a cohesive unit, irrespective of whether or not it is specifically used for mechanically connecting components. Therefore, all of the components of the connector are held together in a captive manner. This makes it easier to handle the connector.

According to one variant, the first engagement element has a first holding surface for abutting against the first undercut and the second engagement element has a second holding surface for abutting against the second undercut. The first holding surface and the second holding surface extend in parallel. Such a connector is constructed in a simple manner. Furthermore, stable component connections can be established with such a connector.

In one example, the connector is constructed symmetrically. This means that the connector is configured such that, selectively, the first engagement element can be anchored in the first undercut and the second engagement element can anchored in the second undercut or the first engagement element can be anchored in the second undercut and the second engagement element can be anchored in the first undercut.

In one variant, the first engagement element and the second engagement element are produced from a metal material. This allows the engagement elements to be anchored with a particularly high degree of reliability in the allocated coupling grooves and in particular the undercuts present at that location.

According to one embodiment, the first engagement element and/or the second engagement element is/are fixedly connected to the urging body. The first engagement element and/or the second engagement element can be produced in one piece with the urging body, e.g. by means of a casting or injection-moulding method. Alternatively, the first engagement element and/or the second engagement element can be connected to the urging body in the course of producing the connector, e.g. by means of a suitable joining method. In both variants, a connector is provided which is structurally particularly simple and thus can be produced in a particularly cost-effective manner. Mounting activities for producing the connector are limited to mounting the first engagement element and/or the second engagement element or can be omitted altogether.

The urging body can have the shape of a circular disk portion or the shape of a circular disk. Therefore, the urging body is constructed in a structurally simple manner and can be produced with low outlay. In addition, such a shape is favourable when it comes to positioning the first engagement element and/or the second engagement element in the respective allocated undercut. A circular disk portion-shaped or circular disk-shaped urging body has comparatively few geometric elements, e.g. corners and edges, which, during movement of the urging body, can undesirably collide with elements of the first component and/or of the second component and can be blocked thereby. On the contrary, such a shape of the urging body is favourable in that, when the urging body comes into contact with the first component and/or the second component, said urging body slides against said component and is thus moved in the direction of the desired position. In this regard, an actuating element of the actuating body, i.e. an element, via which an actuating force or an actuating moment can be introduced into the actuating body, can be arranged centrally in the circular disk portion shape or centrally in the circular disk shape. This results in a uniform, ideally symmetrical force curve.

In one variant, at least one of a first engagement element and second engagement element is designed as an arcuate protrusion. Such engagement elements can be positioned in a particularly simple manner in allocated undercuts. Furthermore, such engagement elements are particularly suitable for cooperating with arcuate groove portions and arcuate undercuts. In such a configuration, the engagement elements can be easily introduced into the respectively allocated undercut by means of a rotational movement of the connector.

According to one embodiment, the connection comprises a third engagement element and a fourth engagement element in addition to the first engagement element and the second engagement element. Preferably, the third engagement element is configured to be anchored in a third undercut. In an advantageous manner, the first coupling groove has the third undercut, wherein the third undercut is effective along a groove depth direction of the first coupling groove. Furthermore, the fourth engagement element is preferably configured to be anchored in a fourth undercut. In an advantageous manner, the second coupling groove has the fourth undercut, wherein the fourth undercut is effective along a groove depth direction of the second coupling groove. The third engagement element can be provided at the same end of the connector as the first engagement element. Alternatively or in addition, the fourth engagement element can be provided at the same end of the connector as the second engagement element. A connector is provided which can be anchored with a particularly high degree of reliability in the first coupling groove and/or in the second coupling groove.

According to one variant, the third engagement element has a third holding surface for abutting against the third undercut and the fourth engagement element has a fourth holding surface for abutting against the fourth undercut. The third holding surface and the fourth holding surface extend in parallel. Such a connector is constructed in a simple manner. Furthermore, stable component connections can be established with such a connector, Preferably, the third holding surface and the fourth holding surface also extend in parallel with the first holding surface and with the second holding surface.

In one example, the connector is also constructed symmetrically. This means that the connector is configured such that, selectively, the third engagement element can be anchored in the third undercut and the fourth engagement element can be anchored in the fourth undercut or the third engagement element can be anchored in the fourth undercut and the fourth engagement element can be anchored in the third undercut.

Preferably, the connector which comprises a first engagement element, a second engagement element, a third engagement element and a fourth element is configured symmetrically in such a manner that each of the engagement elements can be anchored in each of the undercuts. Such a connection can thus be used in four different orientations. Therefore, a user does not need to consider the orientation in which he/she inserts the connector into the coupling grooves. This makes it easier to use the connector.

In one design alternative, one or more of the engagement elements has at least one introduction bevel. This facilitates the introduction of the respective engagement element into an allocated undercut.

In one variant, at least one of the engagement elements is coupled to the urging body via a gear unit. The gear unit ensures that the engagement element can be moved in a specified manner in dependence upon the urging body. Therefore, urging of one of the engagement elements by means of the urging body results in a specified movement of the engagement element and so this can engage reliably and in a specified manner into an allocated undercut.

By means of the gear unit, the first engagement element and/or the second engagement element can be moved selectively into a retracted position or an extended position, e.g. along a thickness direction of the connector. This is effected with a high degree of reliability and precision. The retracted position can be particularly suitable for easily introducing the connector into the first coupling groove and/or the second coupling groove and/or easily removing the connector from the first coupling groove and/or the second coupling groove. The extended position can be configured to anchor the first engagement element and/or the second engagement element in the respectively allocated undercut.

Alternatively or in addition, the first engagement element and/or the second engagement element can be transferred selectively into a retracted position or an extended position e.g. along a longitudinal direction of the connector which extends transversely to the thickness direction of the connector and, in the mounted state, extends along a groove depth direction. This is also effected with a high degree of reliability and precision. The extended position can be particularly suitable for easily introducing the connector into the first coupling groove and/or the second coupling groove and/or easily removing the connector from the first coupling groove and/or the second coupling groove. The extended position can be adapted to the groove depths of the first coupling groove and the second coupling groove in such a manner that the first component and the second component are held at a defined distance from one another when the connector is inserted both into the first coupling groove and the second coupling groove and assumes the extended position. This distance corresponds to an approach path, i.e. a distance, over which the first component and the second component are moved towards one another when the connector is being transferred into the retracted position, until they abut against one another via the respective contact surfaces. It is understood that the first engagement element and the second engagement element must be anchored in the respectively allocated undercut in order to be moved towards or away from one another. The retracted position can be configured such that first and second components to be fastened to one another by means of the connector can be placed against one another. They can be placed against one another in this way by the application of force.

According to one alternative, the urging body is kinematically coupled to at least one of the first engagement element and second engagement element via a gear mechanism. A gear mechanism is understood to be a gear unit which comprises at least one toothed portion which is used for the kinematic coupling. The toothed portion does not necessarily have to extend completely around the circumference of a wheel-shaped element. The toothed portion can also be designed as a toothed rack or as an arcuate toothed segment. One or more gear mechanisms can be provided. Gear mechanisms have a simple and robust structure. Furthermore, with a compact structure they can transmit comparatively large forces and moments. This means that at least one extended position and at least one retracted position can be implemented in a simple manner by means of the gear mechanism.

In one alternative, the urging body is kinematically coupled to at least one of the first engagement element and second engagement element via a primary cam mechanism. In this regard, the designation of the cam mechanism as being primary is merely for ease of explanation. A number of cam mechanisms is not implied. Cam mechanisms have a simple and robust structure. This also makes it possible to achieve a non-uniform transmission between the urging body and the engagement element. This means that at least one extended position and at least one retracted position can be implemented in a simple manner by means of the primary cam mechanism.

The primary cam mechanism can have a cam surface which is arranged on the urging body. Furthermore, the primary cam mechanism can have a counter surface which is allocated to the cam surface and is arranged on at least one of the first engagement element and second engagement element or is operatively connected to at least one of the first engagement element and second engagement element. Therefore, the counter surface is provided directly on the allocated engagement element or on an intermediate element located kinematically between the urging body and the allocated engagement element. In this regard, a counter surface is allocated to the cam surface when it is provided to contact the cam surface in order to form the primary cam mechanism. The cam surface and the counter surface can be of any shape, e.g. curved, in order to effect any desired but specified transmission between a movement of the urging body and a movement of the allocated engagement element.

It is also possible for the primary cam mechanism to have a cam surface, which is arranged on the urging body, and a counter surface which is allocated to the cam surface and is arranged on a coupling element which kinematically couples the urging body to at least one of the first engagement element and second engagement element. The coupling element can be used to bridge e.g. a distance between the urging body and the allocated engagement element. Furthermore, the coupling element can be used to arrange the cam surface and the counter surface in a space-saving manner.

In one example, the coupling element is a coupling slide.

The cam surface of the primary cam mechanism and the allocated counter surface can be self-locking at least in a specified relative position. In this manner, the allocated engagement element can be held in a specified relative position with respect to the urging body by means of the primary cam mechanism.

In a further embodiment, the urging body is kinematically coupled to at least one of the first engagement element and second engagement element via a secondary cam mechanism. In this regard, the designation of the cam mechanism as being secondary is merely for ease of explanation. A number of cam mechanisms is not implied, wherein, in a case in which the connector comprises a primary cam mechanism and a secondary cam mechanism, at least two cam mechanisms are, of course, present. Cam mechanisms have a simple and robust structure. This also makes it possible to achieve a non-uniform transmission between the urging body and the engagement element. This means that at least one extended position and at least one retracted position can be implemented in a simple manner by means of the secondary cam mechanism.

The secondary cam mechanism can have a cam surface which is arranged on the urging body. Furthermore, the secondary cam mechanism can have a counter surface which is allocated to the cam surface and is arranged on at least one of the first engagement element and second engagement element or is operatively connected to at least one of the first engagement element and second engagement element. Therefore, the counter surface is provided directly on the allocated engagement element or on an intermediate element located kinematically between the urging body and the allocated engagement element. In this regard, a counter surface is allocated to the cam surface when it is provided to contact the cam surface in order to form the secondary cam mechanism. The cam surface and the counter surface can be of any shape, e.g. curved, in order to effect any desired but specified transmission between a movement of the urging body and a movement of the allocated engagement element.

The cam surface of the secondary cam mechanism and the allocated counter surface can be self-locking at least in a specified relative position. In this manner, the allocated engagement element can be held in a specified relative position with respect to the urging body by means of the secondary cam mechanism.

In one variant, the primary cam mechanism and the secondary cam mechanism are adapted to one another in such a manner that, when the first component and the second component are being mounted on one another, the first engagement element and the second engagement element are transferred firstly along a thickness direction of the connector into the extended position. Therefore, the first engagement element and the second engagement element are anchored in the respectively allocated undercut. Then, the first engagement element and the second engagement element can be transferred into the retracted position along a longitudinal direction of the connector which extends transversely to the thickness direction of the connector and, in the mounted state, extends along a groove depth direction. Therefore, the first component and the second component are placed against one another. When the primary cam mechanism is used to move the first engagement element and the second engagement element along the thickness direction of the connector into the extended position and the secondary cam mechanism is used to move the first engagement element and the second engagement element along the longitudinal direction into the retracted position, the cam surfaces and counter surfaces which form the primary cam mechanism must firstly interact with one another. Only then can the cam surfaces and counter surfaces which form the secondary cam mechanism interact with one another. When disassembling the first component and the second component from one another, the described steps and procedures are effected in reverse order.

In one design alternative, the connector comprises a carrier, wherein the urging body is mounted on the carrier so as to be rotatable about an axis of rotation. The urging body can be held in a defined position relative to the allocated engagement elements by means of the carrier. Such a connector is particularly reliable in terms of its function. Furthermore, the carrier can be used to position the connector within the first and/or the second coupling groove. In the event that the carrier is used to position the connector both within the first coupling groove and within the second coupling groove, the first component and the second component can be positioned relative to each other by means of the carrier. The carrier can also be used to introduce forces into the connector or extract forces from the connector over a comparatively large surface. The connector can therefore connect the first component and the second component via a high holding force, which, however, results only in comparatively low mechanical stresses within the first component and the second component. Preferably, the carrier is designed having two shells and so the urging body can be at least partially accommodated between the two shells of the carrier.

At least one of the first engagement element and second engagement element can be mounted on the carrier so as to be displaceable in a translational manner. Such translational displaceability can be used to bring the engagement element into engagement with an undercut. Alternatively or in addition, the translational displaceability can be used in order to move the first component and the second component towards one another. As a consequence, the first component and the second component can be placed against one another in a reliable manner.

It is also possible for at least one of the first engagement element and second engagement element to be connected to the carrier in an articulated manner. The articulated joint is formed e.g. by means of a film hinge. Therefore, the engagement element is held on the carrier in a captive manner but is still movable.

In another embodiment, the urging body comprises at least one urging arm which is rotatable about the axis of rotation. Such an urging arm can be used to apply an actuating force precisely and reliably to an allocated engagement element. Furthermore, the urging arm can form a lever element, by means of which comparatively small forces can be converted into comparatively large forces.

The urging arm can be produced from a metal material. Such an urging arm is suitable for particularly high forces and is particularly durable.

At least one cam surface can be arranged on a free end of the urging arm. The free end is to be understood to be an end facing away from the pivot point of the urging arm. As a consequence, the cam mechanism which is allocated to the cam surface is actuated by a movement of the urging arm.

In one exemplified embodiment, at least portions of the urging body are bolt-shaped. Such an urging body is particularly compact. Preferably, a central axis of the bolt coincides with an axis of rotation of the urging body.

At least one cam surface can be arranged on an outer circumference of a bolt-shaped portion of the urging body. The cam mechanism which is allocated to the cam surface is thus actuated by a movement of the urging body.

In one embodiment, the urging body has an actuating element for introducing an actuating force and/or an actuating moment. Therefore, the actuating force and/or the actuating moment can be introduced simply and reliably into the urging body. In one example, the actuating element is designed as an engagement opening. The engagement opening can be adapted to an actuating tool which can engage into the engagement opening in order to actuate the urging body. For example, the engagement opening has a hexagonal cross-section which is configured to receive an end of an Allen key. The engagement opening can be designed as a through-going opening or blind opening.

Preferably, a rotation of the actuating tool of less than 180 degrees, in particular of less than 170 degrees and more particularly of less than 160 degrees, is required in order to mount the first component and the second component to one another. The connector can thus be actuated conveniently by means of the actuating tool. Therefore, it is rarely or never necessary to convert the tool.

The object is also achieved by means of a connector which has a length measured along an insertion direction, a width measured transversely to the insertion direction and a thickness measured transversely to the insertion direction. The thickness is always less than the width. In addition, a ratio of width to length is 1 to 3, preferably 1.4 to 2. The connector can be configured according to one or more of the aforementioned examples and embodiments but does not have to be. In the case of a connector which is two-dimensional or flat bar-shaped, the length, width and thickness can therefore be determined by defining the smallest outer dimension as the thickness. Then, the outer dimension which is oriented in the insertion direction is defined as the length and the remaining outer dimension is defined as the width. The insertion direction is the direction, along which the connector is inserted into the coupling groove or coupling grooves in order to connect allocated components. Such connectors are thus comparatively short in the length direction. As a result, they can be used to connect components which have only comparatively little space in the length direction. This is particularly the case with flat components or with corner connections.

The object is also achieved by means of a component connection. The component connection comprises a first component with at least a first coupling groove, the groove opening of which is located in a first contact surface of the first component and which has a first undercut which is effective along a groove depth direction. The component connection also comprises a second component with at least a second coupling groove, the groove opening of which is located in a second contact surface of the second component and which has a second undercut which is effective along a groove depth direction. Moreover, the component connection comprises a connector in accordance with the invention. Portions of the connector are arranged within the first coupling groove and portions thereof are arranged within the second coupling groove. The first engagement element of the connector engages into the first undercut. The second engagement element of the connector engages into the second undercut. In addition, the first contact surface of the first component and the second contact surface of the second component contact one another. As a result, the part of the connector received in the first coupling groove and the part of the connector received in the second coupling groove complement each other to form the connector as a whole. The undercuts are preferably each arranged in the region of the groove base of the associated groove. Therefore, the first component and the second component are fastened to one another in an extremely reliable manner. Furthermore, such a component connection is space-saving by virtue of the fact that the connector is two-dimensional or flat bar-shaped.

In this regard, at least one of the first coupling groove and second coupling groove can be larger along their direction of progression than a dimension of the portion of the connector received in the first coupling groove or the second coupling groove along the direction of progression of the respectively allocated coupling groove. The respective portion of the connector can thus be displaced along the direction of progression by a certain distance within the allocated coupling groove. This allows the first component and the second component to be fastened to one another in different relative positions along the direction of progression of the first coupling groove or the second coupling groove. This can be used for tolerance compensation. For example, the first and second components can be precisely connected to one another in this manner, even though at least one of the first coupling groove and second coupling groove is subject to a positional deviation or a positioning error.

The first component and the second component can abut against one another fundamentally in any way. In preferred variants, the abutment arrangement is designed as a corner joint, butt joint or mitre joint. Particularly in the last case, the two-dimensional shape or flat bar-shape of the connector is brought to bear because this shape means that it can also be used in the mitre joint.

An access channel for a tool can be provided on the first component and/or on the second component, wherein the access channel extends from a workpiece outer surface as far as into the first coupling groove and/or as far as into the second coupling groove. The urging body, in particular an actuating element of the urging body, can be reliably reached via such an access channel. Therefore, the connector can be actuated in a reliable manner.

According to one variant, the access channel is open in the direction of the allocated contact surface. Such an access channel can also be referred to as a groove. It extends transversely to the allocated coupling groove. A drilling template is not required in order to produce such a transverse groove in a specified relative position with respect to the coupling groove because this groove can be produced starting from the contact surface. The transverse groove can therefore easily be produced, for which purpose a routing machine or a dowel milling machine can be used. Of course, the transverse groove as well as the first coupling groove and the second coupling groove can also be produced by means of an industrial CNC milling machine.

Preferably, the actuating element of the connector is positioned at a coupling groove-side end of the access channel. Therefore, the actuating element can be easily reached with an associated tool.

The invention will be explained hereinafter with the aid of various exemplified embodiments which are illustrated in the attached drawings. In the figures:

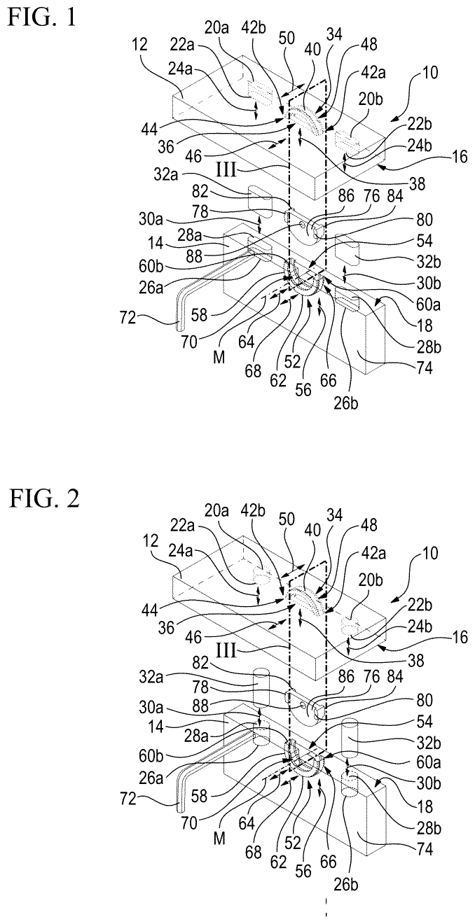

FIG. 1 shows an exploded view of a component connection in accordance with the invention according to a first embodiment, wherein the component connection comprises a connector in accordance with the invention according to a first embodiment,

FIG. 2 shows an exploded view of a component connection in accordance with the invention according to a second embodiment, wherein the component connection likewise comprises the connector in accordance with the invention according to the first embodiment,

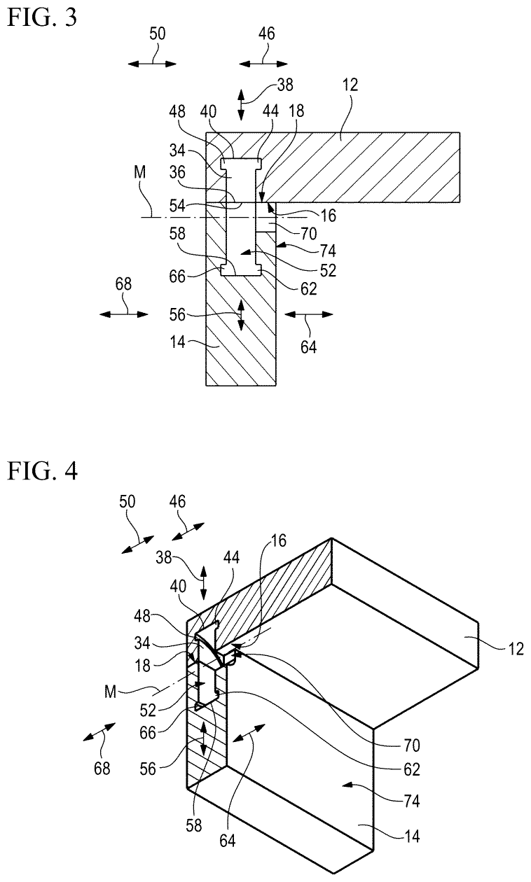

FIG. 3 shows a sectional view along plane III through a first component and a second component of the component connections according to the first embodiment and the second embodiment,

FIG. 4 shows a perspective view of the sectional view of FIG. 3,

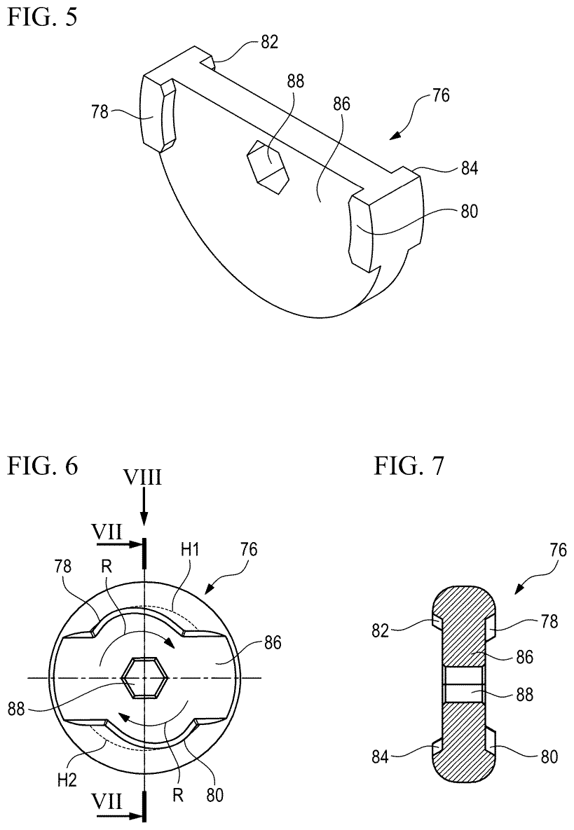

FIG. 5 shows an isolated, perspective view of the connector according to the first embodiment,

FIG. 6 shows a side view of a connector according to a second embodiment,

FIG. 7 shows a sectional view along plane VII-VII through the connector of FIG. 6,

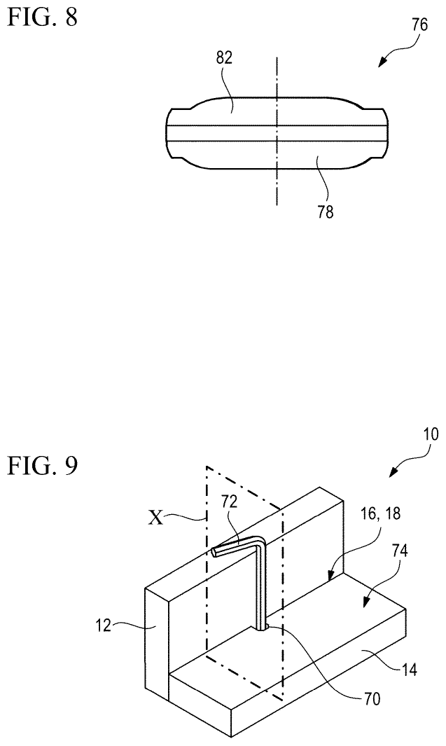

FIG. 8 shows a view of the connector of FIGS. 6 and 7 along the direction VIII in FIG. 6,

FIG. 9 shows a perspective view of a component connection in accordance with the invention according to a third embodiment, wherein the component connection comprises a connector in accordance with the invention according to a third embodiment and wherein an actuating tool is additionally illustrated,

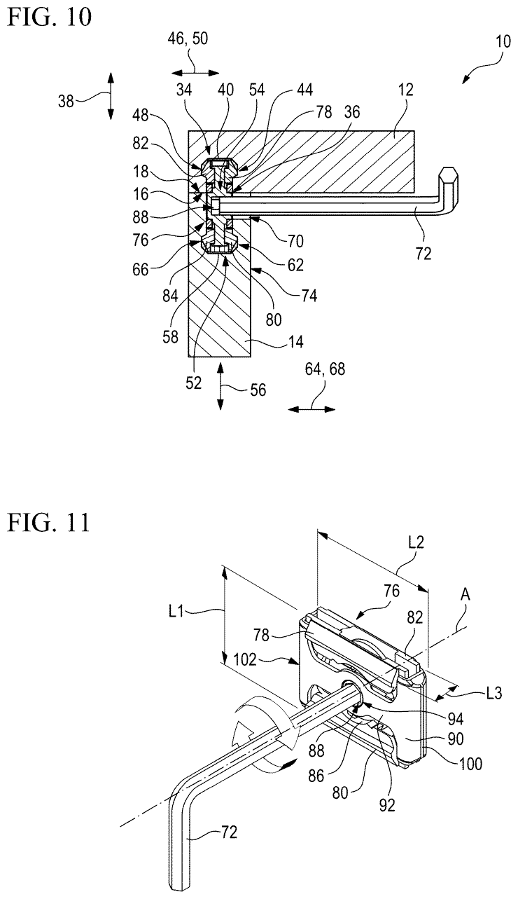

FIG. 10 shows the inventive component connection of FIG. 9 in a sectional view along the plane X, wherein again the actuating tool is additionally illustrated,

FIG. 11 shows a perspective view of the connector according to the third embodiment, wherein the actuating tool is also illustrated,

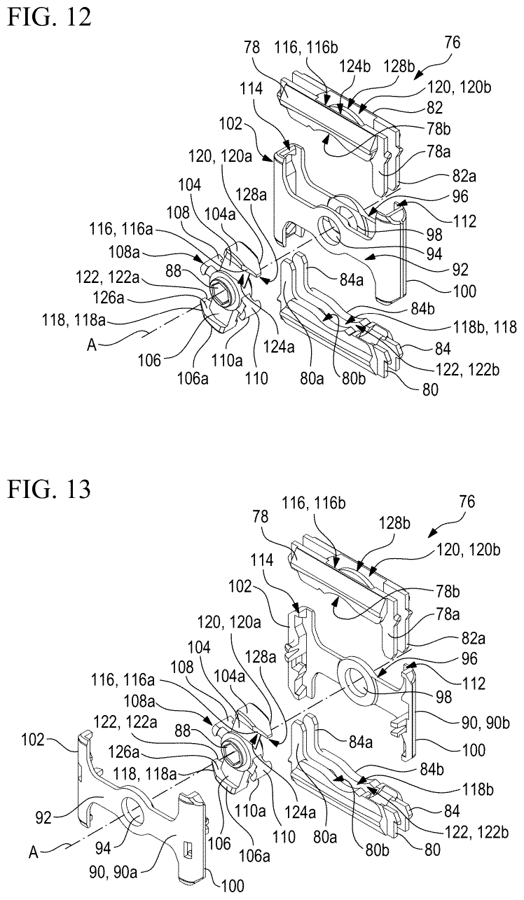

FIG. 12 shows an exploded view of the connector of FIG. 11,

FIG. 13 shows an exploded view of a variant of the connector of FIGS. 11 and 12,

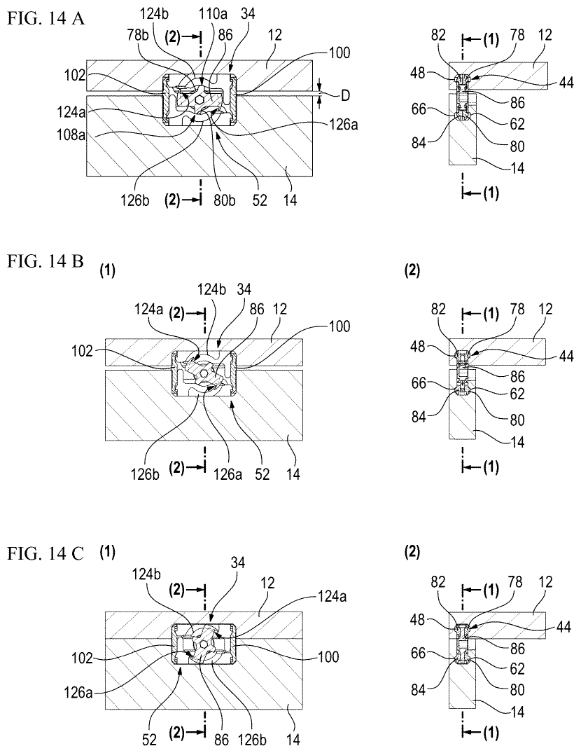

FIG. 14 shows a sequence for producing the component connection according to the third embodiment,

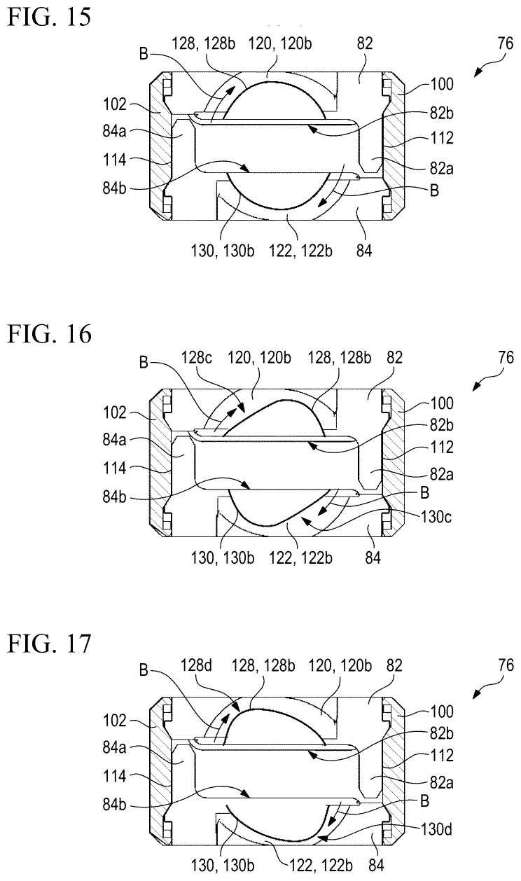

FIGS. 15 to 19 shows further variants of the connector according to the third embodiment,

FIG. 20 shows a component connection according to a fourth embodiment which likewise comprises the connector according to the third embodiment, wherein an actuating tool is additionally illustrated,

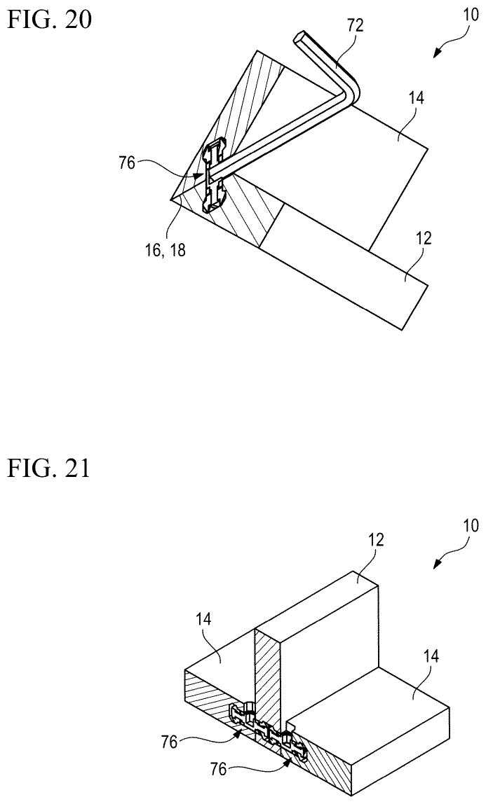

FIG. 21 shows a component connection according to a fifth embodiment which comprises two connectors according to the third embodiment,

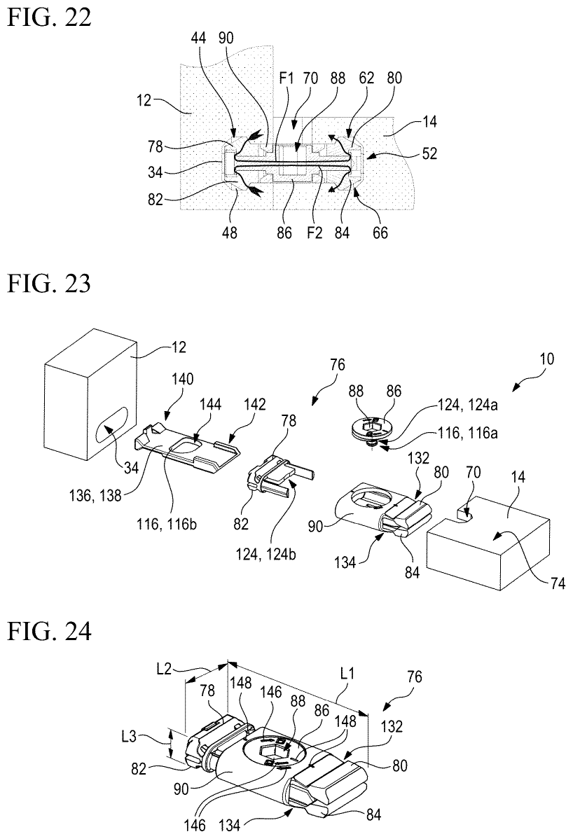

FIG. 22 shows an illustration of a force flow in component connections which use the connector according to the third embodiment,

FIG. 23 shows an exploded view of a component connection according to a sixth embodiment, wherein the component connection comprises a connector according to a fourth embodiment,

FIG. 24 shows an isolated, perspective view of the connector according to the fourth embodiment,

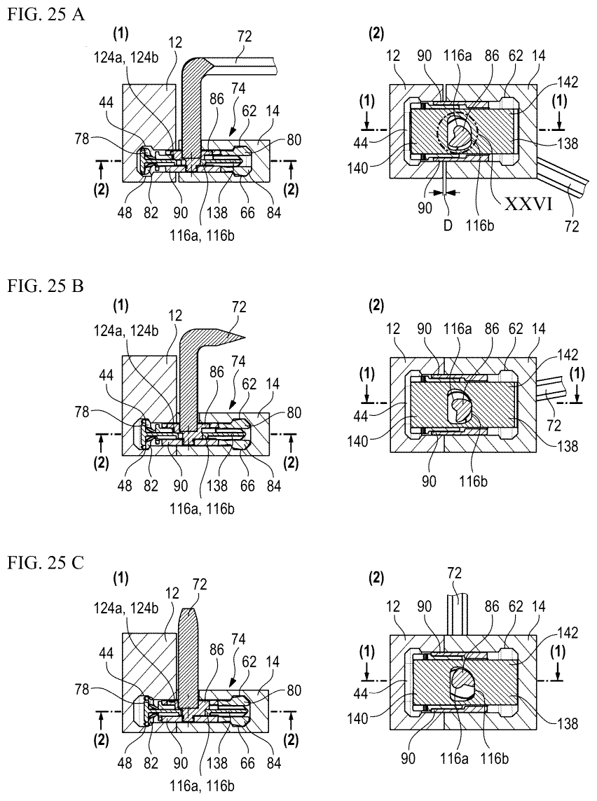

FIG. 25 shows a sequence for producing the component connection according to the sixth embodiment, wherein an actuating tool is additionally illustrated,

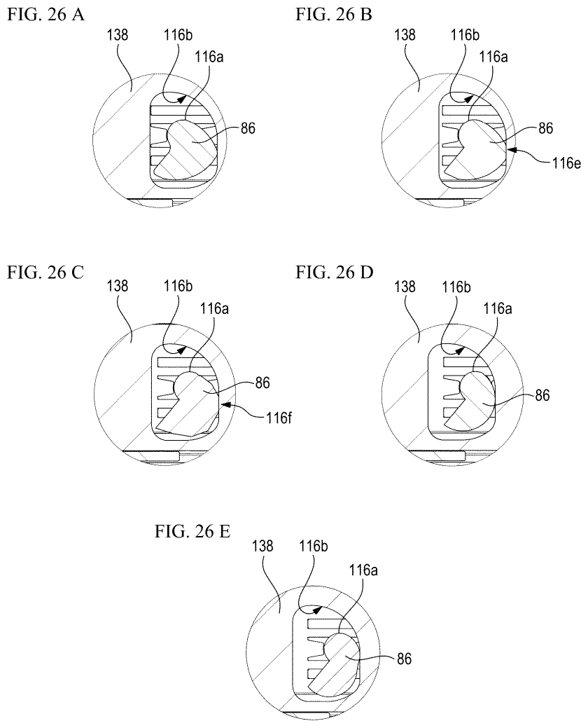

FIG. 26 shows further variants of the connector according to the fourth embodiment,

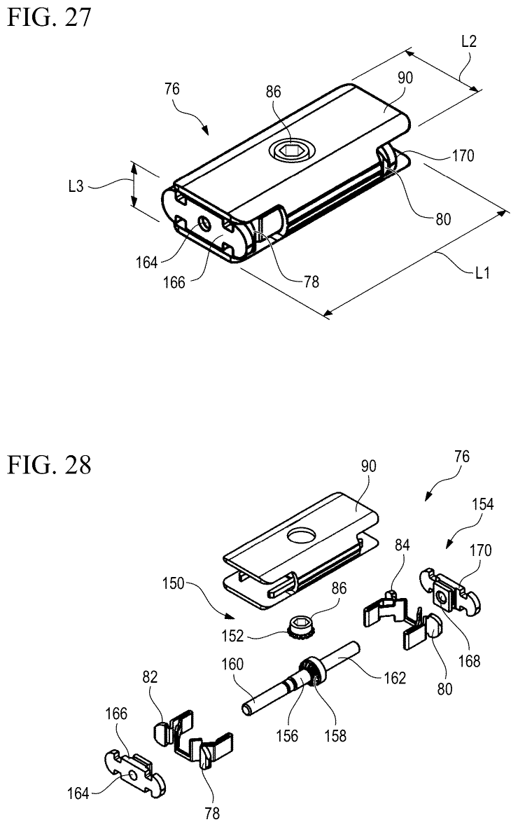

FIG. 27 shows a perspective view of a connector in accordance with the invention according to a fifth embodiment,

FIG. 28 shows an exploded view of the connector of FIG. 27,

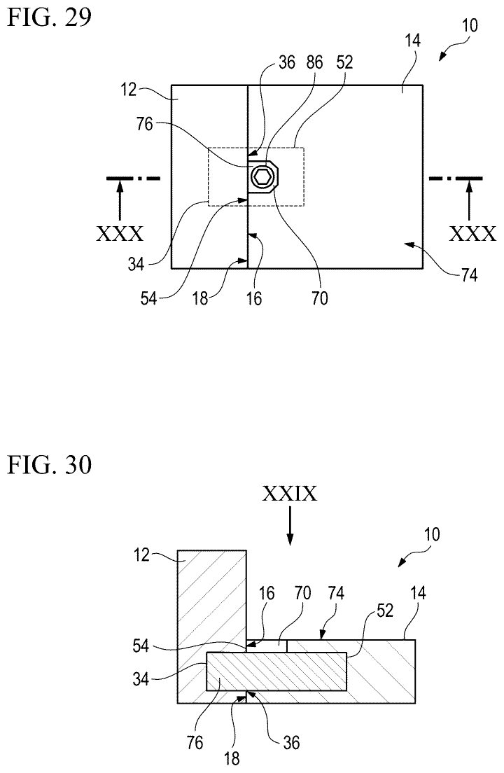

FIG. 29 shows a component connection according to a seventh embodiment in a plan view along the direction XXIX of FIG. 30, wherein the component connection comprises a connector according to the fifth embodiment, and

FIG. 30 shows the component connection of FIG. 29 in a view cut along the plane XXX-XXX in FIG. 29.

FIG. 1 shows a component connection 10 according to a first embodiment.

The component connection comprises a first component 12 and a second component 14.

A first contact surface 16 is provided on the first component 12.

The second component 14 comprises a second contact surface 18.

In a state in which the first component 12 and the second component 14 are fastened to one another, the first contact surface 16 and the second contact surface 18 contact one another (see also FIGS. 3 and 4).

The first component 12 further comprises two positioning grooves 20a, 20b, the groove openings 22a, 22b of which are located in the first contact surface 16.

A respectively allocated groove depth direction 24a, 24b of the positioning grooves 20a, 20b extends thus perpendicularly to the first contact surface 16.

In a plan view of the first contact surface 16, the two positioning grooves 20a, 20b each have a substantially rectangular cross-section, wherein the corners of the rectangular cross-section are rounded. A direction in parallel with the longer side of the rectangular cross-section can be described as the direction of progression or extension direction of the respective positioning groove 20a, 20b.

A groove depth, i.e. a dimension of the positioning grooves 20a, 20b along the respectively allocated groove depth direction 24a, 24b is constant in both positioning grooves 20a, 20b along the direction of progression.

The second component 14 likewise comprises two positioning grooves 26a, 26b, the groove openings 28a, 28b of which are located in the second contact surface 18.

The positioning groove 26a is arranged in such a manner that, in the mounted state of the first component 12 and of the second component 14, the groove opening 28a is opposite the groove opening 22a.

The positioning groove 26b is arranged in such a manner that, in the mounted state of the first component 12 and the second component 14, the groove opening 28b is opposite the groove opening 22b.

A respectively allocated groove depth direction 30a, 30b of the positioning grooves 26a, 20b accordingly extends perpendicularly to the second contact surface 18.

In a plan view of the second contact surface 18, the two positioning grooves 26a, 26b each have a substantially rectangular cross-section, wherein the corners of the rectangular cross-section are rounded. A direction in parallel with the longer side of the rectangular cross-section can be designated as the direction of progression or extension direction of the respective positioning groove 26a, 26b.

A groove depth, i.e. a dimension of the positioning grooves 26a, 26b along the respectively allocated groove depth direction 30a, 30b is constant in both positioning grooves 26a, 26b along the direction of progression.

The component connection 10 further comprises two positioning elements 32a, 32b which, in the embodiment according to FIG. 1, are designed as so-called flat dowels.

In an advantageous manner, the positioning element 32a is arranged in the positioning grooves 20a, 26a with a precise fit, i.e. without any play, and the positioning element 32b is arranged with play in the direction of progression or extension direction of the positioning grooves 20b, 26b.

As can be seen from the view in FIG. 2, the positioning elements 32a, 32b can also be designed as so-called round dowels. For the remainder, the component connection 10 of FIG. 2 corresponds to the component connection 10 of FIG. 1.

In a state in which the first component 12 and the second component 14 are fastened to one another, portions of the positioning element 32a are received in the positioning groove 20a and the positioning groove 26a, wherein the portions of the positioning element 32a received in the positioning grooves 20a, 26a complement one another to form the entire positioning element 32a.

Portions of the positioning element 32b are each received in the positioning groove 20b and the positioning groove 26b respectively, wherein the portions of the positioning element 32b received in the positioning grooves 20b, 26b complement one another to form the entire positioning element 32b.

The positioning elements 32a, 32b have the effect that the first component 12 and the second component 14 can be fastened to one another only in a specified relative position.

The first component 12 also has a first coupling groove 34, the groove opening 36 of which is located in the first contact surface 16 (see also FIGS. 3 and 4).

A groove depth direction 38 of the first coupling groove 34 extends perpendicularly to the first contact surface 16.

However, in contrast to the positioning grooves 20a, 20b, 26a, 26b, a groove base 40 of the first coupling groove 34 is configured as a portion of a circular cylinder peripheral surface. Therefore, a groove depth of the first coupling groove 34 is not constant. On the contrary, the groove depth is zero at a first end 42a of the first coupling groove 34 along the direction of progression, then increases continuously along the direction of progression as far as to a deepest point and then decreases continuously again, so that the groove depth is zero at a second end 42b of the first coupling groove 34 which is opposite the first end along the direction of progression.

A central axis M of the circular cylinder peripheral surface which forms the groove base 40 is located outside the first component 12.

The first coupling groove 34 also has a first undercut 44 which is effective along the groove depth direction 38 and is arranged in the region of the groove base 40.

In the illustrated embodiment, the first undercut is designed as a transverse groove which extends along the groove base 40, wherein a groove depth direction 46 of the transverse groove is in parallel with the central axis M.

Furthermore, the first coupling groove 34 has a third undercut 48 which is effective along the groove depth direction 38 and is arranged in the region of the groove base 40. The third undercut 48 is provided on a wall of the first coupling groove 34 opposite the first undercut 44.

In the illustrated embodiment, the third undercut is designed as a transverse groove which extends along the groove base 40, wherein a groove depth direction 50 of the transverse groove is in parallel with the central axis M.

It is noted that the designation of the undercut as a third undercut is for ease of explanation only and does not imply a number of undercuts.

The second component 14 has a second coupling groove 52, the groove opening 54 of which is located in the second contact surface 18 (see also FIGS. 3 and 4).

The groove opening 54 of the second coupling groove is arranged such that it is opposite the groove opening 36 of the first coupling groove 34 in a state in which the first component 12 and the second component 14 are fastened to one another.

A groove depth direction 56 of the second coupling groove 52 extends perpendicularly to the first contact surface 18.

As already explained with reference to the first coupling groove 34, a groove base 58 of the second coupling groove 52 is formed as a portion of a circular cylinder peripheral surface.

Therefore, a groove depth of the second coupling groove 52 is not constant. On the contrary, the groove depth is zero at a first end 60a of the second coupling groove 52 along the direction of progression, then increases continuously along the direction of progression as far as to a deepest point and then decreases continuously, so that the groove depth is zero at a second end 60b of the second coupling groove 52 which is opposite the first end 60a along the direction of progression.

A central axis M of the circular cylinder peripheral surface which forms the groove base 58 is located within the second component 14, wherein the groove base 58 runs out perpendicularly to the contact surface 18.

In the illustrated embodiment, the central axis M of the groove base 40 of the first coupling groove 34 and the groove base 58 of the second coupling groove 52 coincide when the first component 12 and the second component 14 are fastened to one another.

The second coupling groove 52 also has a second undercut 62 which is effective along the groove depth direction 56 and is arranged in the region of the groove base 58.

In the illustrated embodiment, the second undercut 62 is designed as a transverse groove which extends along the groove base 58, wherein a groove depth direction 64 of the transverse groove is in parallel with the central axis M.

Furthermore, the second coupling groove 52 has a fourth undercut 66 which is effective along the groove depth direction 56 and is arranged in the region of the groove base 58. The fourth undercut 66 is provided on a wall of the second coupling groove 52 opposite the second undercut 62.

In the illustrated embodiment, the fourth undercut 66 is designed as a transverse groove which extends along the groove base 58, wherein a groove depth direction 68 of the transverse groove is in parallel with the central axis M.

Furthermore, an access channel 70 for a tool 72 is provided on the second component 14.

In the figures, the tool 72 is designed as a so-called Allen key which is to be understood merely as an example.

It is emphasised that the tool 72 is only shown to improve understanding of the component connection 10, but does not form part of the component connection 10.

The access channel 70 extends from a workpiece outer surface 74, which in the illustrated example adjoins the second contact surface 18 perpendicularly, as far as into the second coupling groove 52. In other words, the access channel 70 penetrates a side wall of the second coupling groove 52.

Therefore, the tool 72 can reach a connector-to be explained at a later stage-via the access channel 70, said connector being arranged in the second coupling groove 52.

In addition, the access channel 70 is open in the direction of the second contact surface 18.

The access channel 70 can thus be considered to be a groove which extends transversely to the second coupling groove 52, wherein a direction of progression of the groove which forms the access channel is arranged perpendicularly to the direction of progression of the second coupling groove 52, and a groove opening of the groove which forms the access channel 70 is located within the second contact surface 18.

In the illustrated embodiment, the central axis M extends through the access channel 70.

The component connection 10 also comprises a connector 76 according to a first embodiment. This is illustrated in isolation in FIG. 5.

The connector 76 is two-dimensional overall.

It comprises a first engagement element 78 configured to anchor the connector 76 in the first undercut 44, a second engagement element 80 configured to anchor the connector 76 in the second undercut 62, a third engagement element 82 configured to anchor the connector 76 in the third undercut 48, and a fourth engagement element 84 configured to anchor the connector 76 in the fourth undercut 66.

Furthermore, the connector 76 has an urging body 86 which, in the first embodiment illustrated in FIG. 5, is in the shape of a circular disk portion.

An actuating element 88 is provided on the urging body 86.

In the illustrated embodiment, the actuating element 88 is designed as a through-going opening having a hexagonal cross-section. This cross-section is dimensioned in such a manner that it can cooperate with the tool 72.

The actuating element 88 is arranged centrally in the urging body 86 when its circular disk portion shape is conceptually extended to form a complete circular disk. In other words, a central axis of the conceptually extended urging body 86 and a central axis of the actuating element 88 coincide.

The first engagement element 78, the second engagement element 80, the third engagement element 82 and the fourth engagement element 84 are kinematically coupled to the urging body 86, in that the first engagement element 78, the second engagement element 80, the third engagement element 82 and the fourth engagement element 84 are fixedly connected to the urging body 86.

In the illustrated embodiment, the first engagement element 78, the second engagement element 80, the third engagement element 82, the fourth engagement element 84 and the urging body 86 are produced in one piece e.g. as an injection-moulded part.

The first engagement element 78, the second engagement element 80, the third engagement element 82 and the fourth engagement element 84 are each designed as an arcuate protrusion on the urging body 86.

A curvature of the first engagement element 78, the second engagement element 80, the third engagement element 82 and the fourth engagement element 84 each substantially correspond to a curvature of the transverse groove which forms the allocated undercut 44, 48, 62, 66.

The first engagement element 78 and the second engagement element 80 protrude from the same side of the circular disk portion-shaped urging body 86. In FIG. 5, this side of the urging body 86 faces forwards.

In relation to the central axis of the actuating element 88, the first engagement element 78 and the second engagement element 80 are arranged diametrically opposite one another.

The third engagement element 82 and the fourth engagement element 84 also protrude from the same side of the circular disk portion-shaped urging body 86. However, this side is opposite the side, from which the first engagement element 78 and the second engagement element 80 protrude.

In relation to the central axis of the actuating element 88, the third engagement element 82 and the fourth engagement element 84 are also arranged diametrically opposite one another.

In addition, the first engagement element 78 and the third engagement element 82 are arranged next to one another along a direction which is perpendicular to the circular disk portion-shaped urging body 86, i.e. in parallel with the central axis of the actuating element 88. The same applies to the second engagement element 80 and the fourth engagement element 84.

In the component connection 10, the first component 12 and the second component 14 are fastened to one another by means of the connector 76.

Therefore, in order to form the component connection 10, the connector is firstly inserted into the second coupling groove 52 as shown in FIG. 1.

In this state, the actuating element 88 is positioned at a coupling groove-side end of the access channel 70.

Furthermore, the first engagement element 78 and the second engagement element 80 engage into the second undercut 62. The first engagement element 78 and the second engagement element 80 are dimensioned such that they can be received in the groove which forms the second undercut 62.

The third engagement element 82 and the fourth engagement element 84 engage into the fourth undercut 66.

The third engagement element 82 and the second engagement element 84 are also dimensioned such that they can be received in the groove which forms the fourth undercut 66.

The first component 12 and the second component 14 are then inserted one inside the other using the positioning elements 32a, 32b such that the first contact surface 16 and the second contact surface 18 contact one another.

The tool 72 is now brought into engagement with the actuating element 88 via the access channel 70 and the connector 76 is rotated substantially through 90 degrees by means of the tool 72. In the illustrated embodiment, this is effected clockwise.

As a result, the first engagement element 78 and the second engagement clement 82 migrate into the first coupling groove 34.

More precisely, the first engagement element 78 migrates into the first undercut 44 and the third engagement element 82 migrates into the third undercut 48.

At the same time, the second engagement element 80 migrates within the second undercut 62 in the direction of the deepest point of the second coupling groove 52. The fourth engagement element 84 likewise migrates within the second undercut 66 in the direction of the deepest point of the second coupling groove 52.

It is understood that this can be reversed when the connector 76 is rotated in an opposite direction, i.e. anti-clockwise, by means of the tool 72.

Thus, since the actuating element 88 is provided on the urging body 86, the urging body 86 is used to position the first engagement element 78 in the first undercut 44, the second engagement element 80 in the second undercut 62, the third engagement element 82 in the third undercut 48 and the fourth engagement element 84 in the fourth undercut 66.

The first component 12 and the second component 14 are connected by means of the connector 76.

Portions of the connector 76 are arranged within the first coupling groove 34 and portions thereof are arranged within the second coupling groove 52. At the same time, the connector 76 is received completely within the first coupling groove 34 and the second coupling groove 52.

In this regard, the dimensions of the first coupling groove 34, of the second coupling groove 52 and of the connector 76 can be adapted to one another such that the connector 76 can assume the described position only by utilising an elastic elongation of the connector 76 and/or an elastic deformability of the first component 12 and the second component 14 at least in the region of the first coupling groove 34 or the second coupling groove 52. In this regard, independent and undesired backward rotation of the connector 76 is precluded by reason of the frictional forces which are effective between the first coupling groove 34 and the connector 76 and between the second coupling groove 52 and the connector 76.

Alternatively, the first coupling groove 34 and/or the second coupling groove 52 can be configured in such a manner that the respectively allocated groove base 40, 58, which was previously described as a portion of a circular cylinder peripheral surface characterised by a constant radius, is designed as a cam track. This cam track, starting from the shape of a circular cylinder peripheral surface, has a constantly increasing radius along a direction of rotation in which the connector 76 is rotated. In this configuration, when the connector 76 is being rotated by means of the tool 72, the first component 12 and the second component 14 are moved towards one another and are successively clamped by means of the connector.

In this variant also, independent and undesired backward rotation of the connector 76 is precluded by reason of the frictional forces which are effective between the first coupling groove 34 and the connector 76 and between the second coupling groove 52 and the connector 76.

FIGS. 6 and 8 show a second embodiment of the connector 76. The connector 76 according to the second embodiment can be used instead of the connector 76 according to the first embodiment, which is illustrated in FIG. 5, in the component connection 10 according to FIGS. 1 and 2.

Only the differences with respect to the connector 76 according to the first embodiment will be discussed hereinafter. Identical or mutually corresponding elements are designated by the same reference signs.

In the second embodiment, the urging body 86 is in the shape of a complete circular disk.

The first engagement element 78, the second engagement element 80, the third engagement element 82 and the fourth engagement element 84 are again each designed as an arcuate protrusion on the urging body 86.

However, each of the first engagement element 78, second engagement element 80, third engagement element 82 and fourth engagement element 84 is now designed having a surface pointing radially inwards as a cam surface, the radial distance of which from the centre point of the circular disk decreases along the direction R. To see this configuration more clearly, two auxiliary lines H1, H2, each with a constant radius, are indicated in FIG. 6.

The connector 76 according to the second embodiment is screwed into the first coupling groove 34 and the second coupling groove 52 in the same manner as the connector 76 according to the first embodiment in order to connect the first component 12 and the second component 14. By reason of the configuration of the first engagement element 78, the second engagement element 80, the third engagement element 82 and the fourth engagement element 84 with the cam surface described above, rotation of the connector 76 relative to the coupling grooves 34, 52 causes the first component 12 and the second component 14 to be moved towards one another and the connector 76 to become successively clamped in the coupling grooves 34, 52.

It is understood that in all variants of the component connections 10 of FIGS. 1 and 2, the positioning elements 32a, 32b are optional.

FIG. 9 shows a component connection 10 according to a third embodiment.

Only the differences with respect to the first and second embodiment of the component connection 10 will be explained hereinafter. For the remainder, reference can be made to the above explanations. As usual, the same reference signs are used for identical or mutually corresponding elements.

A first difference between the third embodiment of the component connection 10 and the first embodiment and the second embodiment is that in the component connection 10 according to the third embodiment no positioning grooves are present and no positioning elements are used. They are no longer necessary, as will be explained below.

A further difference relates to the progression of the groove bases 40, 58 of the first coupling groove 34 or the second coupling groove 52.

In contrast to the first two embodiments, the groove bases 40, 58 in the third embodiment are designed as planar surfaces which extend substantially in parallel with the first contact surface 16 or to the second contact surface 18.

Furthermore, the first undercut 44 and the third undercut 48 are designed as transverse grooves extending along the groove base 40. The transverse grooves which form the undercuts 44, 48 thus extend in a linear manner in the third embodiment. The associated groove depth directions extend in parallel with a width direction of the first coupling groove 34.

The same applies to the second undercut 62 and the fourth undercut 66. Furthermore, they are designed as transverse grooves extending along the groove base 58. The transverse grooves which form the undercuts 62, 66 thus extend in a linear manner in the third embodiment.

The associated groove depth directions extend in parallel with a width direction of the second coupling groove 52.

An additional difference is that in the component connection 10 according to the third embodiment, a connector 76 according a third embodiment is used. This is illustrated in detail in FIGS. 10, 11 and 12.

The connector 76 according to the third embodiment comprises a carrier 90.

In the variant illustrated in FIGS. 11 and 12, this is designed in one piece and comprises a first double-T-shaped wall element 92 with a first bearing opening 94 and a second double-T-shaped wall element 96 with a second bearing opening 98.

The two wall elements 92, 96 are arranged opposite one another at a certain distance and are each coupled at two respective opposite ends to a connection portion 100, 102.

The two connection portions 100, 102 are configured to abut against respectively opposite ends of the first coupling groove 34 and/or the second coupling groove 52 when the connector 76 is arranged within the first coupling groove 34 and/or within the second coupling groove 52. The first component 12 and the second component 14 can thus be brought to a predefined relative position by means of the carrier 90.

Consequently, the carrier 90 fulfils a function which is assumed by the positioning element 32a and/or the positioning element 32b in the component connection 10 according to the first embodiment and according to the second embodiment.

In a component connection which uses two or more connectors 76 according to the third embodiment, it is also feasible to configure at least one of the first coupling groove 34 and second coupling groove 52 for at least one of the connectors 76 to be larger along their direction of progression than a corresponding dimension of the connector 76. Such a first coupling groove 34 or second coupling groove 52 can be used for tolerance compensation.

The urging body 86 is mounted on the carrier 90 via the first bearing opening 94 and the second bearing opening 98 in such a manner as to be rotatable about an axis of rotation A.

Furthermore, the urging body 86 now comprises a first urging arm 104, a second urging arm 106 and a first holding arm 108 and a second holding arm 110.

The first urging arm 104 and the second urging arm 106 extend in diametrically opposite directions in relation to the axis of rotation A.

The first holding arm 108 and the second holding arm 110 also extend in diametrically opposite directions in relation to the axis of rotation A.

Accordingly, the first urging arm 104, the second urging arm 106, the first holding arm 108 and the second holding arm 110 are also rotatable about the axis of rotation.

The function of the first urging arm 104, the second loading arm 106, the first holding arm 108 and the second holding arm 110 will be explained in detail hereinafter.

The connector 76 according to the third embodiment further comprises a total of four engagement elements, i.e. a first engagement element 78, a second engagement element 80, a third engagement element 82 and a fourth engagement element 84.

Each of the engagement elements 78, 80, 82, 84 is now designed as an independent component. In particular, the engagement elements 78, 80, 82, 84 are thus designed as components which are separate from the urging body 86.

In the variant illustrated in FIGS. 11 and 12, the engagement elements 78, 80, 82, 84 are also designed as identical parts.

Each of the engagement elements 78, 80, 82, 84 is mounted on the carrier 90 so as to be displaceable in a translational manner.

For this purpose, the first engagement element 78 and the third engagement element 82 each have a guide tongue 78a, 82a, which are displaceably mounted in an allocated guide rail 112 formed on the first connection portion 100.

A displacement direction corresponds to the groove depth direction 38, 56 when the connector 76 is arranged in the first coupling groove 34 and/or the second coupling groove 52.

The second engagement element 80 and the fourth engagement element 84 also comprise in each case a guide tongue 80a, 84a. They are displaceably mounted in an allocated guide rail 114 formed on the second connection portion 102.

A displacement direction corresponds to the groove depth direction 38, 56 when the connector 76 is arranged in the first coupling groove 34 and/or the second coupling groove 52.

In the connector 76 according to the third embodiment, the urging body 86 is kinematically coupled to each of the engagement elements 78, 80, 82, 84 in each case via a primary cam mechanism.

All primary cam mechanisms are configured to introduce the allocated engagement element 78, 80, 82, 84 into the associated undercut 44, 48, 62, 66 when the connector 76 is positioned in the first coupling groove 34 and the second coupling groove 52.

In detail, the first engagement element 78 is kinematically coupled to the urging body 86, more precisely the first urging arm 104, via a first primary cam mechanism 116.

The first primary cam mechanism 116 comprises a cam surface 116a which is arranged at a free end of the first urging arm 104. The cam surface 116a extends obliquely in relation to a circumferential direction of the first urging arm 104 which is rotatable about the axis of rotation A.

An associated counter surface 116b is arranged on the first engagement element 78. More precisely, the counter surface 116b is formed on an inner side of the first engagement element 78.

When the cam surface 116a slides against the counter surface 116b, the first engagement element 78 is thus displaced outwards in relation to the carrier 90. The first engagement element 78 is thus transferred into its extended position along the thickness direction of the connector 76.

Analogously thereto, the second engagement element 80 is kinematically coupled to the urging body 86, more precisely the second urging arm 106, via a second primary cam mechanism 118.

The second primary cam mechanism 118 comprises a cam surface 118a which is arranged at a free end of the second urging arm 106. The cam surface 118a extends obliquely in relation to a circumferential direction of the second urging arm 106 which is rotatable about the axis of rotation A.

An associated counter surface 118b is arranged on the second engagement element 80. More precisely, the counter surface 118b is formed on an inner side of the second engagement element 80.

When the cam surface 118a slides against the counter surface 118b, the second engagement element 80 is thus displaced outwards in relation to the carrier 90. The second engagement element 80 is thus transferred into its extended position along the thickness direction of the connector 76

Accordingly, the third engagement element 82 is kinematically coupled to the urging body 86, more precisely the first urging arm 104, via a third primary cam mechanism 120.

The third primary cam mechanism 120 comprises a cam surface 120a which is arranged at a free end of the first urging arm 104. The cam surface 120a extends obliquely in relation to a circumferential direction of the first urging arm 104 which is rotatable about the axis of rotation A.

An associated counter surface 120b is arranged on the third engagement element 82. More precisely, the counter surface 120b is formed on an inner side of the third engagement element 82.

When the cam surface 120a slides against the counter surface 120b, the third engagement element 82 is thus displaced outwards in relation to the carrier 90. The third engagement element 82 is thus transferred into its extended position along the thickness direction of the connector 76.

In this regard, the cam surface 116a and the cam surface 120a are arranged on a head 104a of the first urging arm 104.

When viewed radially, the head 104a has the shape of a wedge which is bevelled on both sides. By actuating the first urging arm 104, it can thus be pushed like a wedge between the first engagement element 78 and the third engagement element 82, so that they are spread apart from one another by means of the head 104a and thus each assume their extended position along the thickness direction of the connector 76.

Furthermore, the fourth engagement element 84 is kinematically coupled to the urging body 86, more precisely the second urging arm 106, via a fourth primary cam mechanism 122.

The fourth primary cam mechanism 122 comprises a cam surface 122a which is arranged at a free end of the second urging arm 106. The cam surface 122a extends obliquely in relation to a circumferential direction of the second urging arm 106 which is rotatable about the axis of rotation A.

An associated counter surface 122b is arranged on the fourth engagement element 84. More precisely, the counter surface 122b is formed on an inner side of the fourth engagement element 84.

When the cam surface 122a slides against the counter surface 122b, the fourth engagement element 84 is thus displaced outwards in relation to the carrier 90. The fourth engagement element 84 is thus transferred into its extended position along the thickness direction of the connector 76.

In this regard, the cam surface 118a and the cam surface 122a are arranged on a head 106a of the second urging arm 106.

When viewed radially, the head 106a has the shape of a wedge which is bevelled on both sides. By actuating the second urging arm 106, it can thus be pushed like a wedge between the second engagement element 80 and the fourth engagement element 84, so that they are spread apart from one another by means of the head 106a and thus each assume their extended position along the thickness direction of the connector 76.

Furthermore, in the connector 76 according to the third embodiment, the urging body is kinematically coupled to each of the engagement elements 78, 80, 82, 84 in each case via a secondary cam mechanism.

All secondary cam mechanisms are configured to translationally pull the associated engagement element 78, 80, 82, 84 along the direction specified by the respective guide rail 112, 114 towards a centre point of the connector 76. The secondary cam mechanisms thus cause the respectively associated engagement elements 78, 80, 82, 84 to be transferred into their retracted position in a longitudinal direction of the connector.

In a situation in which the connector 76 is positioned in the first coupling groove 34 and the second coupling groove 52 and the engagement elements 78, 80, 82, 84 engage into a respectively associated undercut 44, 48, 62, 66, the first component 12 and the second component 14 can be moved towards one another and/or, where appropriate, placed against one another with the application of force by means of the secondary cam mechanisms.

In detail, the first engagement element 78 is kinematically coupled to the urging body 86, more precisely the first urging arm 104, via a first secondary cam mechanism 124.

The first secondary cam mechanism 124 comprises a cam surface 124a which is arranged at a free end of the first urging arm 104. The cam surface 124a is formed on a radially inwards facing side of the head 104 and has the shape of a circular cylinder peripheral surface portion, i.e. it is curved with a constant radius. An axis of curvature extends in parallel with the axis of rotation A.

An associated counter surface 124b is arranged on a protrusion on an inner side of the first engagement element 78. The counter surface 124b faces radially outwards in relation to the axis of rotation A.

The counter surface 124b is also curved about an axis of curvature which extends in parallel with the axis of rotation A. However, the radius of curvature is not constant but instead increases continuously along an actualing direction.

When the cam surface 124a slides against the counter surface 124b, the first engagement element 78 is thus pulled inwards, i.e. in the direction of the axis of rotation A, in relation to the carrier 90. The first engagement element 78 is thus transferred into the retracted position in relation to the longitudinal direction of the connector 76.

The second engagement element 80 is kinematically coupled to the urging body 86, more precisely the second urging arm 106, via a second secondary cam mechanism 126.

The second secondary cam mechanism 126 comprises a cam surface 126a which is arranged at a free end of the second urging arm 106. The cam surface 126a is formed on a radially inwards facing side of the head 106a and has the shape of a circular cylinder peripheral surface portion, i.e. it is curved with a constant radius. An axis of curvature extends in parallel with the axis of rotation A.

An associated counter surface 126b is arranged on a protrusion on an inner side of the second engagement element 80. The counter surface 126b faces radially outwards in relation to the axis of rotation A.

The counter surface 126b is also curved about an axis of curvature which extends in parallel with the axis of rotation A. However, the radius of curvature is not constant but instead increases continuously along an actuating direction.

When the cam surface 126a slides against the counter surface 126b, the second engagement element 80 is thus pulled inwards, i.e. in the direction of the axis of rotation A, in relation to the carrier 90. The second engagement element 80 is thus transferred into the retracted position in relation to the longitudinal direction of the connector 76.

The third engagement element 82 is also kinematically coupled to the urging body 86, more precisely the first urging arm 104, via a third secondary cam mechanism 128.

The third secondary cam mechanism 128 comprises a cam surface 128a which is arranged at a free end of the first urging arm 104. The cam surface 128a is formed on a radially inwards facing side of the head 104a and has the shape of a circular cylinder peripheral surface portion, i.e. it is curved with a constant radius. An axis of curvature extends in parallel with the axis of rotation A.

An associated counter surface 128b is arranged on a protrusion on an inner side of the third engagement element 82. The counter surface 128b faces radially outwards in relation to the axis of rotation A.

The counter surface 128b is also curved about an axis of curvature which extends in parallel with the axis of rotation A. However, the radius of curvature is not constant but instead increases continuously along an actuating direction.

When the cam surface 128a slides against the counter surface 128b, the third engagement element 82 is thus pulled inwards, i.e. in the direction of the axis of rotation A, in relation to the carrier 90. The third engagement element 82 is thus transferred into the retracted position in relation to the longitudinal direction of the connector 76,

Furthermore, the fourth engagement element 84 is kinematically coupled to the urging body 86, more precisely the second urging arm 106, via a fourth secondary cam mechanism 130.

The fourth secondary cam mechanism 130 comprises a cam surface 130a which is arranged at a free end of the second urging arm 106. The cam surface 130a is formed on a radially inwards facing side of the head 106a and has the shape of a circular cylinder peripheral surface portion, i.e. it is curved with a constant radius. An axis of curvature extends in parallel with the axis of rotation A.

An associated counter surface 130b is arranged on a protrusion on an inner side of the fourth engagement element 84. The counter surface 130b faces radially outwards in relation to the axis of rotation A.

The counter surface 130b is also curved about an axis of curvature which extends in parallel with the axis of rotation A. However, the radius of curvature is not constant but instead increases continuously along an actuating direction.

When the cam surface 130a slides against the counter surface 130b, the fourth engagement element 84 is thus pulled inwards, i.e. in the direction of the axis of rotation A, in relation to the carrier 90. The fourth engagement element 84 is thus transferred into the retracted position in relation to the longitudinal direction of the connector 76.

The first holding arm 108 and the second holding arm 110 serve to hold the respectively allocated engagement elements 78, 80, 82, 84 in a specified position when the primary cam mechanisms 116, 118, 120, 122 and/or the secondary cam mechanisms 124, 126, 128, 130 are not yet operative, e.g. because the urging arms 104, 106 are located in a position in which they do not contact the engagement elements 78, 80, 82, 84.

In the illustrated third embodiment of the connector 76, the first holding arm 108 is allocated to the first engagement element 78 and the third engagement element 82. The first holding arm 108 has a radially outwards facing holding surface 108a.

Opposite this holding surface 108a, the first engagement element 78 has a counter holding surface 78b and the third engagement element 82 has a counter holding surface 82b. They can abut against the holding surface 108a when the first holding arm is in the corresponding position, so that the first engagement element 78 and the third engagement element 82 cannot be displaced further in the direction of the axis of rotation A.

The second holding arm 110 is allocated to the second engagement element 80 and the fourth engagement element 84. The second holding arm 110 also has a radially outwards facing holding surface 110a.

Opposite this holding surface 110a, the second engagement element 82 has a counter holding surface 82b and the fourth engagement element 84 has a counter holding surface 84b. These can abut against the holding surface 110a when the second holding arm 110 is in the corresponding position, so that the second engagement element 80 and the fourth engagement element 84 cannot be displaced further in the direction of the axis of rotation A.

FIG. 13 shows a variant of the connector 76 according to the third embodiment which differs from the variant in FIGS. 11 and 12 only in that the carrier 90 is constructed from two carrier components 90a, 90b.

In addition, the carrier components 90a, 90b are designed as identical parts.

Otherwise, the connector 76 of FIG. 13 corresponds to the connector of FIGS. 11 and 12.

All connectors 76 according to the third embodiment have a length L1 which is measured along the extension direction. In addition, the connectors 76 have a width L2 measured transversely to the insertion direction and have a thickness L3 also measured transversely to the insertion direction.

The thickness L3 is always less than the width L2. The thickness L3 is thus always the smallest outer dimension of the connector 76 which is two-dimensional or flat bar-shaped.

In the case of all of the connectors 76 according to the third embodiment as shown in the figures, a ratio of the width L2 to the length L1 is 1 to 3. In preferred variants, this ratio is 1.4 to 2. Therefore, the width L2 is precisely equal to or greater than the length L1.

FIG. 14 shows a sequence for producing the component connection 10 according to the third embodiment, as illustrated in FIGS. 9 and 10. The component connection 10 comprises the connector 76 according to the third embodiment, as illustrated in FIGS. 11 and 12.

In this regard, FIG. 14 shows three situations which follow one another during production of the component connection 10. These situations are designated by a), b) and c). Each situation a), b), c) is illustrated by two sectional views. These are designated by (1) and (2) in each situation, wherein the section is defined in the other figure in each case, i.e. section (1) is defined in view (2) and vice versa.

In situation a), the connector 76 is inserted both into the first coupling groove 34 and into the second coupling groove 52. The urging body 86 is located in a position in which the holding surface 108a of the first holding arm 108 abuts against the counter holding surfaces 78b, 82b of the first engagement element 78 and the third engagement element 82.

The holding surface 110a of the second holding arm 110 abuts against the counter holding surfaces 80b, 84b of the second engagement element 80 and of the fourth engagement element 81.

The length of the holding arms 108, 110 and the positions of the counter holding surfaces 78b, 80b, 82b, 84b on the engagement elements 78, 80, 82, 84 are adapted to the groove depths of the first coupling groove 34 and of the second coupling groove 52 such that a gap of the width D is produced between the first contact surface 16 and the second contact surface 18 when the connector 76 abuts both against the groove base 40 and the groove base 58.

The engagement elements 78, 80, 82, 84 do not yet engage into the allocated undercuts 44, 48, 62. 66.

Furthermore, the connection portions 100, 102 each abut both against an end of the first coupling groove 34 and an end of the second coupling groove 52. Therefore, the first component 12 and the second component 14 assume a specified relative position with respect to one another.

In situation b), the urging body 86 is rotated in the clockwise direction by approximately 15 degrees compared to situation a). The clockwise direction thus corresponds to the actuating direction of the urging body 86.

In this regard, the urging body 86 can be rotated e.g. by means of a tool, not illustrated in FIG. 14, which engages into the actuating element 88.

In situation b), the engagement elements 78, 80, 82, 84 are now spread by means of the respectively allocated primary cam mechanism 116, 118, 120, 122, so that they engage into the respectively allocated undercuts 44, 48, 62, 66.

As far as the secondary cam mechanisms 124, 126, 128, 130 are concerned, the allocated cam surfaces 124a, 126a, 128a, 130a already abut against a portion of the allocated counter surfaces 124b, 126b, 128b, 130b located at the front along the actuating direction. However, these portions are configured such that the secondary cam mechanisms 124, 126, 128, 130 do not yet cause any movement of the engagement elements 78, 80, 82, 84. Such a movement would also be blocked by the holding arms 108, 110 which still abut against the allocated counter surfaces 78b, 80b, 82b, 84b in situation b).

In situation c), the urging body 86 is rotated in the clockwise direction by approximately 90 degrees compared to situation a).

The cam surfaces 124a, 126a, 128a, 130a of the secondary cam mechanisms 124, 126, 128, 130 interact with the portions of the allocated counter surfaces 124b, 126b, 128b, 130b located further back in the actuating direction such that the engagement elements 78, 80, 82, 84 are pulled translationally in the direction of the axis of rotation A in each case by means of the secondary cam mechanisms 124, 126, 128, 130.

This results in the first contact surface 16 and the second contact surface 18 contacting one another. This contact can be influenced by force.

In the position prevailing in situation c), the secondary cam mechanisms 124, 126, 128, 130 can also be self-locking. Therefore, the first component 12 is fastened to the second component 14 in a reliable manner.

The above explanations relate to a component connection 10 according to the third embodiment which is designed as a corner connection.

FIGS. 15 to 19 show further variants of the connector 76 according to the third embodiment.

In all of FIGS. 15 to 19, the connector 76 is illustrated cut along a central plane.

Furthermore, to improve clarity, the urging body 86 is not illustrated in any of FIGS. 15 to 19.

Only portions of the carrier are illustrated so that only cut parts of the connection portions 100, 102 can be seen. In particular, the wall elements 92, 96 thus cannot be seen.

The variants of FIGS. 15 to 19 relate to the configuration of the counter surfaces of the secondary cam mechanisms. On account of the sectional view of the connector, the explanations are given on the basis of the counter surface 128b of the third secondary cam mechanism 128 and the counter surface 130b of the fourth secondary cam mechanism 130. It is understood that the explanations apply in the same manner to the remaining secondary cam mechanisms 124, 126.

In this regard, FIG. 15 shows a variant in which the counter surface 128b and the counter surface 130b extend in a manner analogous to the views in FIGS. 11 to 14.

The counter surface 128b and the counter surface 130b thus have a radius of curvature which increases continuously to a small extent along the actuating direction B. This results in a moderate increase in force when the third engagement element 82 and the fourth engagement element 84 are being pulled. Furthermore, the third engagement element 82 and the fourth engagement element 84 are moved uniformly towards one another with regard to their displacement path.

In contrast thereto, the counter surface 128b and the counter surface 130b in the variant shown in FIG. 16 each have a portion 128c, 130c which is flattened compared to the variant shown in FIG. 15 and which is located at the front along the actuating direction B.

When the third secondary cam mechanism 128 and the fourth secondary cam mechanism 130 are being actuated, a force necessary to move the engagement elements 82, 84 thus increases very slowly, but ends at a level which is comparable to that of the variant shown in FIG. 15.

This is associated with a comparatively slow movement of the engagement elements 82, 84 towards one another.

The variant in FIG. 17 shows the reverse scenario.

In this case, the counter surface 128b and the counter surface 130b each have a portion 128d, 130d which is steeply inclined compared to the variant shown in FIG. 15 and which is located at the front along the actuating direction B.

When the third secondary cam mechanism 128 and the fourth secondary cam mechanism 130 are being actuated, a comparatively high force is thus initially necessary to move the engagement elements 82, 84.

This is associated with a comparatively rapid movement of the engagement elements 82, 84 towards one another.

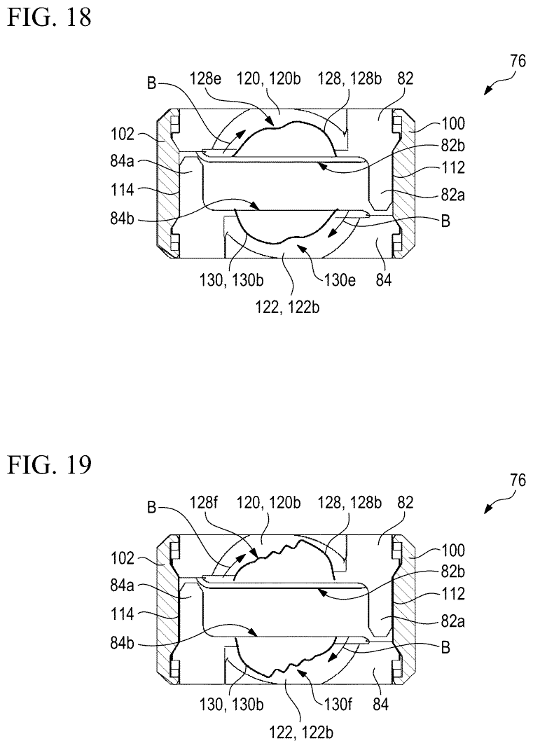

In the variant shown in FIG. 18, the counter surface 128b and the counter surface 130b each have a holding portion 128e, 130e. A holding portion 128e, 130e is to be understood to be a portion of the counter surfaces 128b, 130b, during interaction whereof with the allocated cam surface 128a, 130a the engagement elements 82, 84 are not moved towards one another or are moved towards one another only to an insignificant extent.

The third secondary cam mechanism 128 and the fourth secondary cam mechanism 130 can thus be actuated in two stages, wherein, in a first stage, the respective cam surface 128a, 130a is moved as far as to the allocated holding section 128e, 130e and, in a second stage, is moved further starting from the holding portion 128e, 130e.

In the variant of FIG. 19, the counter surface 128b and the counter surface 130b each have a latching portion 128f, 130f.

Each of the latching portions 128f, 130f comprises a serrated profile, a wave profile or a combined serrated and wave profile. The respectively allocated cam surface 128a, 130a can thus hook into latching portions 128f, 130f by engaging into one or more associated spaces between serrations and/or waves.

In this way, on the one hand, an operator of the connector 67 can be signalled haptically and/or acoustically that a desired operating state of the connector 67 is achieved.

Furthermore, the latching portions 128f, 130f increase the self-locking of the allocated secondary cam mechanism 128, 130. Such connectors 67 thus offer a high degree of protection against undesired release.

It is understood that the variants of FIGS. 15 to 19 which have been explained with reference to the third embodiment of the connector 76 can also be transferred to the connector 76 according to the second embodiment (cf. in particular FIG. 6).

Therefore, the radially inwards facing surfaces of the engagement elements 78, 80, 82, 84, which interact with the undercuts 44, 48, 62, 66 of the coupling grooves 34, 52 and are formed as cam surfaces, of which the radial distance from the centre point of the circular disk is reduced along the direction R, can also be provided with holding portions or latching portions, as shown in FIGS. 18 and 19.

It is also possible, in accordance with the variants shown in FIGS. 16 and 17, to provide the radially inwards facing surfaces of the engagement elements 78, 80, 82, 84, of the connector 76 according to the second embodiment with flattened portions and/or steeply inclined portions, so that a desired force and displacement progression is provided when the components 12, 14 are fastened to one another by means of the connector 76.

The variants of FIGS. 15 to 19 which have been explained with reference to the third embodiment of the connector 76 can also be transferred to component connections which utilise the connector 76 according to the first embodiment (see FIGS. 1 to 5).

In this regard, a holding portion and/or a latching portion can be provided on at least one of the surfaces forming one of the undercuts 44, 48, 62, 66 of the coupling grooves 34, 52.

It is also possible to provide a flattened portion and/or a steeply inclined portion on at least one of the surfaces forming one of the undercuts 44, 48, 62, 66. Therefore, a desired force and displacement progression can be set when the components 12, 14 are fastened to one another by means of the connector 76 according to the first embodiment.

However, as can be clearly seen in FIG. 20, the connector 76 according to the third embodiment can also be used in a component connection 10 according to a fourth embodiment which is configured as a mitre joint.

Likewise, the connector 76 according to the third embodiment can also be used in a component connection 10 according to a fifth embodiment which is configured as a centre part connection. This is illustrated in FIG. 21. More precisely, two connectors 76 according to the third embodiment are used in this case.

FIG. 22 shows a variant of the component connection according to the third embodiment. As usual, the component connection 10 comprises the connector 76 according to the third embodiment.

In the variant shown in FIG. 22, all engagement elements 78, 80, 82, 84 and the urging body 86 are produced from a metal material.

The carrier 90 is produced from a synthetic material.

This results in a situation where a force flow between the first component 12 and the second component 14 is effected exclusively via components consisting of metal material. This is illustrated in FIG. 22 by means of two arrows F1, F2.

FIG. 23 illustrates a component connection 10 according to a further embodiment.

Again, only the differences with respect to the already explained embodiments of the component connection 10 will be explained hereinafter. As usual, the same reference signs are used for identical or mutually corresponding elements.

In particular, in the embodiment shown in FIG. 23, the first component 12 with the first coupling groove 34 and the second component 14 with the second coupling groove 52 correspond, with regard to the general configuration of the coupling grooves 34, 52, to the components 12, 14 already explained with reference to FIGS. 9 and 10. Reference is made to these explanations.

However, one difference with respect to the preceding embodiments is that in the component connection 10 shown in FIG. 23, a connector 76 according a fourth embodiment is used. This is illustrated in detail in FIG. 24.

The connector 76 according to the fourth embodiment comprises a one-piece carrier 90, on which the urging body 86 is rotatably mounted.

However, the urging body 86 is now substantially bolt-shaped, as will be explained later.

Furthermore, the second engagement element 80 and the fourth engagement element 84 are now each connected to the carrier 90 in an articulated manner.

In the illustrated embodiment, the second engagement element 80 and the fourth engagement element 84 are produced in one piece with the carrier 90. The articulated connection is established in each case by means of a film binge 132, 134. Translational guidance of the second engagement element 80 and the fourth engagement element 84 on the carrier is thus no longer necessary.

Furthermore, the first engagement element 78 and the third engagement element 82 are now designed as an integral component. However, the first engagement element 78 and the third engagement element 82 can still be moved relative to one another in order to be able to engage into the allocated undercuts.

Moreover, the connector 76 according to the fourth embodiment comprises a coupling element 136 in the form of a coupling slide 138.

The coupling slide 138 comprises a first wedge portion 140 which is configured to spread the first engagement element 78 and the third engagement element 82 apart from one another so that these engagement elements 78, 82 can engage into the allocated undercuts.

Furthermore, the coupling slide 138 has a second wedge portion 142 provided thereon which is configured to spread the second engagement element 80 and the fourth engagement element 84 apart from one another so that these engagement elements 80, 84 can engage into the allocated undercuts.

In addition, in the connector 76 according to the fourth embodiment, only a single primary cam mechanism 116 is provided which can also be referred to as the first primary cam mechanism.

The coupling element 136, i.e. the coupling slide 138, is kinematically coupled to the urging body 86 via the primary cam mechanism 116.

The primary cam mechanism 116 comprises a cam surface 116a which is arranged on an outer circumference of the bolt-shaped urging body 86 (see also FIG. 25).

An associated counter surface 116b is formed by an inner circumference of an opening 144 on the coupling element 136, i.e. on the coupling slide 138 (see also FIG. 25).

Thus, when the cam surface 116a slides against the counter surface 116b, the coupling slide 138 is translationally displaced such that its first wedge portion 140 is pulled between the first engagement element 78 and the third engagement element 82 such that they are spread apart from one another. At the same time, the second wedge portion 142 is pushed between the second engagement element 80 and the fourth engagement element 84 in such a manner that they are spread apart from one another.

FIG. 25 a) shows a situation during the production of a component connection 10 in which such spreading results in the engagement of the engagement elements 78, 80, 82, 84 into the respectively allocated undercut 44, 48, 62, 66.

Furthermore, the connector 76 according to the fourth embodiment comprises a single secondary cam mechanism 124 which can also be referred to as a first secondary cam mechanism.

The secondary cam mechanism 124 comprises a cam surface 124a which is arranged on an outer circumference of the bolt-shaped urging body 86. The cam surface 124a is arranged, in relation to a bolt central axis, in an axially adjacent manner to the cam surface 116a.

An associated counter surface 124b is formed on the integral component which comprises the first engagement element 78 and the third engagement element 82.

When the cam surface 124a slides against the counter surface 124b, a displacement of the integral component, which comprises the first engagement element 78 and the third engagement element 82, in the direction of the urging body 86 is successively enabled.

FIG. 25 shows a sequence for producing the component connection 10 according to the embodiment of FIG. 23. The component connection 10 comprises the connector 76 according to the fourth embodiment, as illustrated in FIGS. 23 and 24.

In this regard, FIG. 25 shows three situations which follow one another during production of the component connection 10. These situations are designated by a), b) and c). Each situation a), b), c) is illustrated by two sectional views. These are designated by (1) and (2) in each situation, wherein the section is defined in the other figure in each case, i.e. section (1) is defined in view (2) and vice versa.

In situation a), the connector 76 is inserted both into the first coupling groove 34 and into the second coupling groove 52. The urging body 86 has already been rotated by approximately 65 degrees from an initial position, which, in the present example, is effected by means of the tool 72 which engages into the actuating element 88.

Therefore, in situation a), the engagement elements 78, 80, 82, 84 are spread by means of the primary cam mechanism 116 and the coupling slide 138 which comprises the first wedge portion 140 and the second wedge portion 142, so that they engage into the respectively allocated undercuts 44, 48, 62, 66.

As far as the secondary cam mechanism 124 is concerned, the allocated cam surface 124a and the allocated counter surface 124b abut against one another, thereby establishing a specified distance between the carrier 90 and the integral component which comprises the first engagement member 78 and the third engagement member 82.

For this reason, there is also a gap with the width D between the first contact surface 16 and the second contact surface 18.

In this regard, the cam surface 124a and the counter surface 124b are held in contact with one another by virtue of the fact that the coupling slide 138 spreads the first engagement element 78 and the third engagement element 82 apart from one another by means of the first wedge portion and thereby also urges the integral component, which comprises the first engagement element 78 and the third engagement element 82, in the direction of the urging body 86.

In situation b), the urging body 86 has been rotated by approximately a further 35 degrees compared to situation a). Firstly, the primary cam mechanism 116 has been used to displace the coupling slide 138 further. In addition, the secondary cam mechanism 124 has enabled a translational movement of the integral component, which comprises the first engagement element 78 and the third engagement element 82, relative to the carrier 90, so that the integral component, which comprises the first engagement element 78 and the third engagement element 82, could be displaced into the carrier 90, and the first contact surface 16 and the second contact surface 18 could be placed against one another. Therefore, there is no longer a gap between the first contact surface 16 and the second contact surface 18.

In situation c), the urging body 86 has been rotated by approximately a further 80 degrees compared to situation b). Firstly, the primary cam mechanism 116 has been used to displace the coupling slide 138 further. In addition, the secondary cam mechanism 124 has enabled a continuing translational movement of the integral component, which comprises the first engagement element 78 and the third engagement element 82, relative to the carrier 90, so that the integral component, which comprises the first engagement element 78 and the third engagement element 82, has been displaced to a maximum extent into the carrier 90. Therefore, the first contact surface 16 and the second contact surface 18 abut against one another when force is applied.

In the position prevailing in situation c), the primary cam mechanism 116 and the secondary cam mechanism 124 can also be designed to be self-locking. Therefore, the first component 12 is fastened to the second component 14 in a reliable manner.

In order to further facilitate handling of the connector 76 according to the fourth embodiment, a direction indicator 146 can optionally be provided on the urging body 86 and/or on the carrier 90, said direction indicator indicating a direction of rotation of the urging body 86 corresponding to the closing direction of the connector 76. In the embodiment illustrated in FIG. 24, the direction indicator 146 comprises three arrows. It is understood that only one of these arrows or two of these arrows can form a useful direction indicator 146.

Furthermore, the connector 76 according to the fourth embodiment can optionally have one or more position indicators 148. The position indicators show the position in which the urging body 86 is located relative to the other components of the connector 76. It is thus possible to see whether the connector is in an opened or closed position. Intermediate positions can also be seen. In the embodiment according to FIG. 24, the position indicator 148 comprises three short lines. Two of these lines are positioned on the carrier 90 and one of these lines is provided on the urging body 86.

FIG. 26 shows further variants of the connector 76 according to the fourth embodiment.

FIG. 26 illustrates only the relevant details of the connector 76. They correspond to the detail XXVI of FIG. 25 a) (1).

To aid understanding, FIG. 26 (a) illustrates the detail XXVI of FIG. 25 a) (1) on a larger scale. It is possible to see therein the primary cam mechanism 116 which comprises the cam surface 116a and the counter surface 116b.

In this variant, the coupling slide 138 is initially displaced comparatively quickly by means of rotation of the urging body 86. In the region of the end position (see also FIG. 25 b) and c)), a comparatively high force must be applied in order to be able to rotate the urging body 86 further and therefore to be able to displace the coupling slide 138 further. In this region, a comparatively slow displacement of the coupling slide 138 takes place.

In the variant of FIG. 26 (b), the cam surface 116a comprises a holding portion 116e.

Therefore, the primary cam mechanism 116 can be actuated in two stage, wherein, in a first stage, the cam surface 116a is moved as far as to the allocated holding portion 116e, i.e. until the holding portion 116e abuts against the counter surface 116b. In a second stage, the urging body 86 is rotated further starting from this position.

The holding portion 116e can be configured in such a manner that automatic movement of the components of the connector 76 is precluded when the holding portion 116e abuts against the counter surface 116b.

In the variant shown in FIG. 26(c), the cam surface 116a comprises a latching portion 116f. This is composed of a plurality of planar surface segments. Therefore, there are no radii but instead edges present at the boundary lines between the individual surface segments.

The rolling of these edges on the counter surface 116b causes jerky changes in the reaction force acting upon an actuating tool. In this way, on the one hand, an operator of the connector 67 can be signalled haptically and/or acoustically when a desired operating state of the connector 67 is achieved.

Furthermore, the latching portion 116f increases the self-locking of the allocated primary cam mechanism 116. Such connectors 67 thus offer a high degree of protection against undesired release.

FIG. 25(d) shows one variant in which a path, along which the coupling slide 138 is displaced, and a force necessary for this purpose have a particularly uniform progression. This is achieved in that there are no abrupt changes in radius in the effective region of the cam surface 116a, i.e. a radius of the cam surface 116a changes only continuously. A rate of change is comparatively low.

A further variant is shown in FIG. 25(e).

In this variant, the coupling slide 138 is initially displaced comparatively slowly by means of rotation of the urging body 86. A necessary force also increases comparatively slowly. For this purpose, a comparatively short portion of the cam surface 116 is provided. Therefore, an end position (see for this purpose also FIG. 25 b) and c)) is achieved comparatively quickly.

FIGS. 27 and 28 show a connector 76 according to a fifth embodiment. Only the differences with respect to the connectors 76 already explained will be discussed hereinafter.

Again, the connector 76 according to the fifth embodiment comprises a one-piece carrier 90, on which the urging body 86 is rotatably mounted. Likewise, the urging body 86 is substantially bolt-shaped, more precisely circular-cylindrical.

In addition, in the connector 76 according to the fifth embodiment, the first engagement element 78 and the third engagement element 82 are formed by means of a common component, at least portions of which are elastically deformable, as will also be explained hereinafter.

The second engagement element 80 and the fourth engagement element 84 are formed by means of a common component, at least portions of which are likewise elastically deformable.

The component by means of which the first engagement element 78 and the third engagement element 82 are formed and the component by means of which the second engagement element 80 and the fourth engagement element 84 are formed are separate from one another. In addition, these components are arranged at opposite ends of the carrier 90.

Moreover, in the connector 76 according to the fifth embodiment, the engagement elements 78. 80, 82, 84 are kinematically coupled to the urging body 86 via a gear mechanism 150.

The gear mechanism 150 comprises a drive gear 152 which, in the present case, is integrally formed with the urging body 86. In this regard, a tooth arrangement of the drive gear 152 extends circumferentially completely around a periphery of a circular-cylindrical urging body 86.

The drive gear 152 is designed as a bevel wheel.

Furthermore, the gear mechanism 150 comprises a threaded rod assembly 154.

The threaded rod assembly 154 comprises a threaded rod 156, on which a driven gear 158 is arranged. The driven gear 158 is fixedly connected to the threaded rod 156.

The driven gear 158 is also designed as a bevel wheel.

The drive gear 152 and the driven gear 158 mesh with one another. A central axis of the drive gear 152 and a central axis of the driven gear 158 extend perpendicularly to one another.

A first threaded portion 160 is provided at a first end of the threaded rod 156.

A second threaded portion 162 is provided at a second end of the threaded rod 156 which is opposite the first end.

The first threaded portion 160 is screwed into a threaded bore 164 of a first pressure piece 166.

The second threaded portion 162 is screwed into a threaded bore 168 of a second pressure piece 170.

The first pressure piece 166 is guided linearly on the carrier 90 and is arranged adjacent to the component which forms the first engagement element 78 and the third engagement element 82.

The second pressure piece 170 is likewise guided linearly on the carrier 90 and is arranged adjacent to the component which forms the second engagement element 80 and the fourth engagement element 84.

Thus, when the urging body 86 is rotated, the first pressure piece 166 can be moved towards or away from the component, which forms the first engagement element 78 and the third engagement element 82, by reason of the kinematic coupling by means of the gear mechanism 150 in such a manner that the first engagement element 78 and the third engagement element 82 protrude with respect to the carrier 90 by virtue of elastic deformation or retract into the interior of the carrier 90 by reason of elastic deformation.

In the same manner, the second pressure piece 170 can be moved towards or away from the component, which forms the second engagement element 80 and the fourth engagement element 84, in such a manner that the second engagement element 80 and the fourth engagement element 84 protrude with respect to the carrier 90 by virtue of elastic deformation or retract into the interior of the carrier 90 by reason of elastic deformation.

In this manner, the engagement elements 78, 80, 82, 84 can engage into or be disengaged from the respectively allocated undercuts 44, 48, 62, 66, provided that the connector 76 is arranged in the coupling grooves 34, 52.

FIGS. 29 and 30 show a variant of the component connection 10 in which the connector 76 according to the fifth embodiment is used. The connector 76 and the coupling grooves 34, 52 are illustrated only in greatly simplified form.

However, it is understood that in the variant shown in FIGS. 29 and 30, the first component 12 and the second component 14 are also fastened to one another, in that the engagement elements 78, 80, 82, 84 engage into the respectively allocated undercuts 44, 48, 62, 66,

For the remainder, reference can be made to the above explanations.

### LIST OF REFERENCE SIGNS

10 component connection
12 first component
14 second component
16 first contact surface
18 second contact surface
20a positioning groove
20b positioning groove
22a groove opening of the positioning groove 20a
22b groove opening of the positioning groove 20b
24a groove depth direction of the positioning groove 20a
24b groove depth direction of the positioning groove 20b
26a positioning groove
26b positioning groove
28a groove opening of the positioning groove 26a
28b groove opening of the positioning groove 26b
30a groove depth direction of the positioning groove 26a
30b groove depth direction of the positioning groove 26b
32a positioning element
32b positioning element
34 first coupling groove
36 groove opening of the first coupling groove
38 groove depth direction of the first coupling groove
40 groove base of the first coupling groove
42a first end of the first coupling groove
42b second end of the first coupling groove
44 first undercut
46 groove depth direction of the transverse groove forming the first undercut
48 third undercut
50 groove depth direction of the transverse groove forming the third undercut
52 second coupling groove
54 groove opening of the second coupling groove
56 groove depth direction of the second coupling groove
58 groove base of the second coupling groove
60a first end of the second coupling groove
60b second end of the second coupling groove
62 second undercut
64 groove depth direction of the transverse groove forming the second undercut
66 fourth undercut
68 groove depth direction of the transverse groove forming the fourth undercut
70 access channel
72 tool
74 workpiece outer surface
76 connector
78 first engagement element
78a guide tongue of the first engagement element
78b counter holding surface of the first engagement element
80 second engagement element
80a guide tongue of the second engagement element
80b counter holding surface of the second engagement element
82 third engagement element
82a guide tongue of the third engagement element
82b counter holding surface of the third engagement element
84 fourth engagement element
84a guide tongue of the fourth engagement element
84b counter holding surface of the fourth engagement element
86 urging body
88 actuating element
90 carrier
90a carrier component
90b carrier component
92 first wall element
94 first bearing opening
96 second wall element
98 second bearing opening
100 connection portion
102 connection portion
104 first urging arm
104a head of the urging arm
106 second urging arm
106a head of the second urging arm
108 first holding arm
108a holding surface of the first holding arm
110 second holding arm
110a holding surface of the second holding arm
112 guide rail
114 guide rail
116 first primary cam mechanism
116a cam surface of the first primary cam mechanism
116b counter surface of the first primary cam mechanism
118 second primary cam mechanism
118a cam surface of the second primary cam mechanism
118b counter surface of the second primary cam mechanism
120 third primary cam mechanism
120a cam surface of the third primary cam mechanism
120b counter surface of the third primary cam mechanism
122 fourth primary cam mechanism
122a cam surface of the fourth primary cam mechanism
122b counter surface of the fourth primary cam mechanism
124 first secondary cam mechanism
124a cam surface of the first secondary cam mechanism
124b counter surface of the first secondary cam mechanism
126 second secondary cam mechanism
126a cam surface of the second secondary cam mechanism
126b counter surface of the second secondary cam mechanism
128 third secondary cam mechanism
128a cam surface of the third secondary cam mechanism
128b counter surface of the third secondary cam mechanism
128c flattened portion
128d steeply inclined portion
128e holding portion
128f latching portion
130 fourth secondary cam mechanism
130a cam surface of the fourth secondary cam mechanism
130b counter surface of the fourth secondary cam mechanism
130c flattened portion
130d steeply inclined portion
130e holding portion
130f latching portion
132 film hinge
134 film hinge
136 coupling element
138 coupling slide
140 first wedge portion
142 second wedge portion
144 opening
146 direction indicator
148 position indicator
150 gear mechanism
152 drive gear
154 threaded rod assembly
156 threaded rod
158 driven gear
160 first threaded portion
162 second threaded portion
164 threaded bore of the first pressure piece
166 first pressure piece
168 threaded bore of the second pressure piece
170 second pressure piece
A axis of rotation
B actuating direction
D width of the gap
F1 arrow
F2 arrow
HI auxiliary line
H2 auxiliary line
L1 length of the connector
L2 width of the connector
L3 thickness of the connector
M central axis
R direction, along which the radius is reduced

1. A connector for mechanically fastening a first component to a second component, wherein the first component bas at least a first coupling groove which bas a first undercut which is effective along a groove depth direction, and the second component has at least a second coupling groove which has a second undercut which is effective along a groove depth direction,
wherein the connector is two-dimensional or flat bar-shaped and comprises:
a first engagement element for anchoring in the first undercut,
a second engagement element for anchoring in the second undercut, and
an urging body for positioning at least a portion of the first engagement element in the first undercut and at least a portion of the second engagement element in the second undercut,
wherein the urging body is kinematically coupled to the first engagement element and the second engagement element.

2-4. (canceled)

5. The connector as claimed in claim 1, wherein the urging body is kinematically coupled to the first engagement element and/or the second engagement element via a gear unit.

6. The connector as claimed in claim 5, wherein the urging body is kinematically coupled to the first engagement element and/or the second engagement element via a gear mechanism.

7. The connector as claimed in claim 5, wherein the urging body is kinematically coupled to the first engagement element and/or the second engagement element via a primary cam mechanism.

8. The connector as claimed in claim 7, wherein the primary cam mechanism has a cam surface, which is arranged on the urging body, and a counter surface which is allocated to the cam surface and is arranged on at least one of the first engagement element and/or the second engagement element or is operatively connected to the first engagement element and/or the second engagement element.

9. The connector as claimed in claim 7, wherein the primary cam mechanism has a cam surface, which is arranged on the urging body, and a counter surface which is allocated to the cam surface and is arranged on a coupling element which kinematically couples the urging body to the first engagement element and/or the second engagement element.

10. The connector as claimed in claim 7, wherein the urging body is kinematically coupled to the first engagement element and/or the second engagement element via a secondary cam mechanism.

11. The connector as claimed in claim 10, wherein the secondary cam mechanism has a cam surface, which is arranged on the urging body, and a counter surface which is allocated to the cam surface and is arranged on the first engagement element and/or the second engagement element or is operatively connected to the first engagement element and/or the second engagement element.

12. The connector as claimed in claim 7, further comprising:
a carrier,
wherein the urging body is mounted on the carrier and is configured to rotate about an axis of rotation.

13. The connector as claimed in claim 12, wherein the first engagement element and/or the second engagement element is mounted on the carrier and is configured to be displaceable in a translational manner.

14. The connector as claimed in claim 12, wherein the first engagement element and/or the second engagement element is connected to the carrier in an articulated manner.

15. The connector as claimed in claim 12, wherein the urging body comprises at least one urging arm which is rotatable about the axis of rotation.

16. The connector as claimed in claim 15, wherein at least one cam surface is arranged on a free end of the urging arm.

17. The connector as claimed in claim 12, wherein at least one portion of the urging body is bolt-shaped.

18. The connector as claimed in claim 17, wherein at least one cam surface is arranged on an outer circumference of at least one bolt-shaped portion of the urging body.

19. The connector according to claim 1, wherein the connector has a length measured along an insertion direction, a width measured transversely to the insertion direction and a thickness measured transversely to the insertion direction, wherein the thickness is always less than the width, wherein a ratio of the width to the length is 1 to 3.

20. Component A component connection, comprising:
a first component with at least a first coupling groove, of which the la groove opening is located in a first contact surface of the first component and which has a first undercut which is effective along a groove depth direction, a second component with at least a second coupling groove, of which the groove opening is located in a second contact surface of the second component and which has a second undercut which is effective along a groove depth direction, and
a connector as claimed in claim 1,
wherein at least one portion of the connector is are arranged within the first coupling groove and at least one portion thereof is are arranged within the second coupling groove,
wherein the first engagement element of the connector engages into the first undercut and the second engagement element of the connector engages into the second undercut, and
wherein the first contact surface of the first component and the second contact surface of the second component contact one another.

21. The component connection as claimed in claim 20, wherein an access channel for a tool is provided on the first component and/or on the second component, wherein the access channel extends from a workpiece outer surface as far as into the first coupling groove and/or as far as into the second coupling groove.

22. The component connection as claimed in claim 21, wherein the access channel is open in a the direction of the allocated contact surface.

23. The component connection as claimed in claim 21, wherein an actuating element of the connector is positioned at a coupling groove-side end of the access channel.
